(19) United States
(12) Patent Application Publication
(10) Pub. No.: US 2016/0050921 A1
(43) Pub. Date: Feb. 25, 2016

(54) COMPOSITIONS AND METHODS FOR ENHANCING PLANTH GROWTH

(71) Applicant: NOVOZYMES BIOAG A/S, Bagsvaerd (DK)

(72) Inventors: Bret Gygi, Brookfield, WI (US); John Kosanke, Brookfield, WI (US); Patrick Reed, Mosinee, WI (US)

(73) Assignee: NOVOZYMES BIOAG A/S, Bagsvaerd (DK)

(21) Appl. No.: 14/780,329

(22) PCT Filed: Mar. 27, 2014
(86) PCT No.: PCT/US2014/031950

§ 371 Date: Sep. 25, 2015

Related U.S. Application Data
(60) Provisional application No. 61/805,701, filed on Mar. 27, 2013.

(51) Int. Cl. A01N 43/16

(52) U.S. Cl. CPC A01N 43/16

(57) ABSTRACT

Described herein are compositions comprising one or more flavonoids or derivatives thereof for enhancing plant growth and methods for treating plants, plant parts with one or more flavonoids and derivatives thereof.

### FIELD

Compositions comprising flavonoids and methods of using the flavonoid compositions to enhance plant growth.

### BACKGROUND

Plant growth depends at least in part on interactions between the plant and microorganisms that inhabit the surrounding soil. For example, the symbiosis between the gram-negative soil bacteria, Rhizobiaceae and Bradyrhizobiaceae, and legumes such as soybean, is well documented. The biochemical basis for these relationships includes an exchange of molecular signaling, wherein the plant-to-bacteria signal compounds include flavonoids (e.g., flavones, isoflavones, flavanones, etc.) and the bacteria-to-plant signal compounds, which include the end products of the expression of the bradyrhizobial and rhizobial nod genes, known as lipo-chitooligosaccharides (LCOs). The symbiosis between these bacteria and the legumes enables the legume to fix atmospheric nitrogen for plant growth, thus obviating a need for nitrogen fertilizers. Since nitrogen fertilizers can significantly increase the cost of crops and are associated with a number of polluting effects, the agricultural industry continues its efforts to exploit this biological relationship and develop new agents and methods for improving plant yield without increasing the use of nitrogen-based fertilizers.

Certain molecules, such as flavonoids, have been recognized as potentially useful in the agricultural industry. Flavonoids are phenolic compounds having the general structure of two aromatic rings connected by a three-carbon bridge. Flavonoids are produced by plants and have many functions, e.g., as beneficial signaling molecules, and as protection against insects, animals, fungi and bacteria. Classes of flavonoids include are known in the art. See, Jain, et al., J. Plant Biochem. & Biotechnol. 11:1-10 (2002); Shaw, et al., Environmental Microbiol. 11:1867-80 (2006).

U.S. Pat. App. No.: 2009/0305895 discloses the use of a one or more isoflavonoid compounds which may be, with an agriculturally acceptable carrier, applied prior to planting, up to 365 days or more, either directly to the seed or transplant of a non-legume crop or a legume crop, or applied to the soil that will be planted either to a non-legume crop or a legume crop, for the purpose of increasing yield and/or improving seed germination and/or improving earlier seed emergence and/or improving nodulation and/or increasing crop stand density and/or improving plant vigour and/or improving plant growth, and/or increasing biomass, and/or earlier fruiting, all including in circumstances of seedling and plant transplanting.

U.S. Pat. No. 5,141,745 discloses a structurally related class of molecules, substituted flavones, which stimulate nodulation gene expression and elicit faster initiation of nodulation in legumes.

Canadian Pat. No.: 2,179,879 discloses the use of the flavonoids genistein or daidzein plus a strain of B. japonicum on legumes grown under environmental conditions that inhibit or delay nodulation, specifically low root zone temperatures between 17° C. and 25° C.

A need remains, however, for compositions and methods for improving plant growth.

### SUMMARY

Described herein are compositions comprising one or more flavonoids or derivatives thereof and methods comprising the foliar application of one or more flavonoids to promote plant growth.

In one embodiment, the compositions described herein comprise a carrier and one or more flavonoids. The flavonoids may include any flavonoid as well as isomers, salts, or solvates thereof.

In another embodiment, the composition comprises one or more flavonoids, a carrier, and one or more agriculturally beneficial ingredients, such as one or more biologically active ingredients, one or more micronutrients, one or more biostimulants, one or more preservatives, one or more polymers, one or more wetting agents, one or more surfactants, one or more herbicides, one or more fungicides, one or more insecticides, or combinations thereof.

In one embodiment, the composition described herein comprises a flavonoid, a carrier, and one or more biologically active ingredients. Biologically active ingredients may include one or more plant signal molecules other than a flavonoid as described herein. In a specific embodiment, the one or more biologically active ingredients may include one or more lipo-chitooligosaccharides (LCOs), one or more chitooligosaccharides (COs), one or more chitinous compounds, one or more non-flavonoid nod gene inducers and derivatives thereof, one or more karrikins and derivatives thereof, or any signal molecule combination thereof. In another embodiment, the composition described herein may further comprise one or more fertilizers.

Further described herein is a method for enhancing the growth of a plant or plant part comprising contacting a plant or plant part with one or more flavonoids for enhancing plant growth. The flavonoids may include flavonoids as well as isomers, salts, or solvates thereof. The method may further comprise subjecting the plant or plant part to one or more agriculturally beneficial ingredients, applied simultaneously or sequentially with the one or more flavonoids. The one or more agriculturally beneficial ingredients can include one or more biologically active ingredients, one or more micronutrients, one or more biostimulants, or combinations thereof. In one embodiment, the method further comprises subjecting the plant or plant part to one or more biologically active ingredients. Biologically active ingredients may one or more plant signal molecules other than a flavonoid as described herein. In a specific embodiment, the one or more biologically active ingredients may include one or more LCOs, one or more chitinous compounds, one or more COs, one or more non-flavonoid nod gene inducers and derivatives thereof, one or more karrikins and derivatives thereof, or any signal molecule combination thereof.

In a specific embodiment described herein, is a method for enhancing the growth of a plant or plant part comprising foliarly applying one or more flavonoids to the plant or plant part. In a more particular embodiment, the method comprises applying one or more flavonoids to plant foliage. The flavonoids may include flavonoids as well as isomers, salts, or solvates thereof. The method may further comprise subjecting the plant or plant part to one or more agriculturally beneficial ingredients, applied simultaneously or sequentially with the one or more flavonoids.

### DETAILED DESCRIPTION

The disclosed embodiments relate to compositions and methods for enhancing plant growth.

### DEFINITIONS

As used herein, the singular forms “a”, “an” and “the” means the plural forms as well, unless the context clearly indicates otherwise.

As used herein, the term “agriculturally beneficial ingredient(s)” means any agent or combination of agents capable of causing or providing a beneficial and/or useful effect in agriculture.

As used herein, “biologically active ingredient(s)” means biologically active ingredients (e.g., plant signal molecules, other microorganisms, etc.) other than the one or more flavonoids described herein.

As used herein the terms “signal molecule(s)” or “plant signal molecule(s)”, which may be used interchangeably with “plant growth-enhancing agent(s),” broadly means any agent, both naturally occurring in plants or microbes, and synthetic (and which may be non-naturally occurring) that directly or indirectly activates or inactivates a plant biochemical pathway, resulting in increased or enhanced plant growth, compared to untreated plants or plants harvested from untreated seed other than the one or more flavonoids described herein.

As used herein, the term “flavonoid(s)” means flavanols, flavones, anthocyanidins, isoflavonoids, neoflavonoids and all isomer, solvate, hydrate, polymorphic, crystalline form, non-crystalline form, and salt variations thereof.

As used herein, the term “flavanols” means flavan-3-ols (e.g., catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), etc.), flavan-4-ols, flavan-3,4-diols (e.g., leucoanthocyanidin), and proanthocyanidins (e.g., includes dimers, trimer, oligomers, or polymers of flavanols).

As used herein, the term “flavones” means flavones (e.g., luteolin, apigenin, tangeritin, etc.), flavonols (e.g., quercetin, quercitrin, rutin, kaempferol, kaempferitrin, astragalin, sophoraflavonoloside, myricetin, fisetin, isorhamnetin, pachypodol, rhamnazin, etc.), flavanones (e.g. hesperetin, hesperidin, naringenin, eriodictyol, homoeriodictyol, etc.), and flavanonols (e.g., dihydroquercetin, dihydrokaempferol, etc.).

As used herein, the term “anthocyanidins” means anthocyanidins, cyanidins, delphinidins, malvidins, pelargonidins, peonidins, and petunidins.

As used herein, the term “isoflavonoids” means phytoestrogens, isoflavones (e.g., genistein, daidzein, glycitein, etc.), and isoflavanes (e.g., equol, lonchocarpane, laxiflorane, etc.).

As used herein, the term “neoflavonoids” means neoflavones (e.g., calophyllolide), neoflavenes (e.g., dalbergichromene), coutareagenins, dalbergins, and nivetins.

As used herein, the term “isomer(s)” means all stereoisomers of the compounds and/or molecules referred to herein (e.g., flavonoids, LCOs, COs, chitinous compounds, jasmonic acid or derivatives thereof, linoleic acid or derivatives thereof, linolenic acid or derivatives thereof, kerrikins, etc.), including enantiomers, diastereomers, as well as all conformers, roatmers, and tautomers, unless otherwise indicated. The compounds and/or molecules disclosed herein include all enantiomers in either substantially pure levorotatory or dextrorotatory form, or in a racemic mixture, or in any ratio of enantiomers. Where embodiments disclose a (D)-enantiomer, that embodiment also includes the (L)-enantiomer; where embodiments disclose a (L)-enantiomer, that embodiment also includes the (D)-enantiomer. Where embodiments disclose a (+)-enantiomer, that embodiment also includes the (−)-enantiomer; where embodiments disclose a (−)-enantiomer, that embodiment also includes the (+)-enantiomer. Where embodiments disclose a (S)-enantiomer, that embodiment also includes the (R)-enantiomer; where embodiments disclose a (R)-enantiomer, that embodiment also includes the (S)-enantiomer. Embodiments are intended to include any diastereomers of the compounds and/or molecules referred to herein in diastereomerically pure form and in the form of mixtures in all ratios. Unless stereochemistry is explicitly indicated in a chemical structure or chemical name, the chemical structure or chemical name is intended to embrace all possible stereoisomers, conformers, rotamers, and tautomers of compounds and/or molecules depicted.

As used herein, the terms “effective amount”, “effective concentration”, or “effective dosage” means the amount, concentration, or dosage of the one or more flavonoids sufficient to cause enhanced plant growth. The actual effective dosage in absolute value depends on factors including, but not limited to, the size (e.g., the area, the total acreage, etc.) of the land for application with the one or more flavonoids, synergistic or antagonistic interactions between the other active or inert ingredients which may increase or reduce the growth enhancing effects of the one or more flavonoids, and the stability of the one or more flavonoids in compositions and/or as plant or plant part treatments. The “effective amount”, “effective concentration”, or “effective dosage” of the one or more flavonoids may be determined, e.g., by a routine dose response experiment.

As used herein, the term “carrier” means an “agronomically acceptable carrier.” An “agronomically acceptable carrier” means any material which can be used to deliver the actives (e.g., flavonoids described herein, agriculturally beneficial ingredient(s), biologically active ingredient(s), etc.) to a plant or a plant part (e.g., plant foliage) etc., and preferably which carrier can be applied (to the plant, plant part (e.g., foliage), or soil) without having an adverse effect on plant growth, soil structure, soil drainage or the like.

As used herein, the term “foliar-compatible carrier” means any material which can be added to a plant or plant part without causing/having an adverse effect on the plant, plant part, plant growth, plant health, or the like.

As used herein, the term “nutrient(s)” means nutrients (e.g., vitamins, macrominerals, trace minerals, organic acids, etc.) which are needed for plant growth, plant health, and/or plant development.

As used herein, the term “biostimulant(s)” means any agent or combination of agents capable of enhancing metabolic or physiological processes within plants and soils.

As used herein, the term “herbicide(s)” means any agent or combination of agents capable of killing weeds and/or inhibiting the growth of weeds (the inhibition being reversible under certain conditions).

As used herein, the term “fungicide(s)” means any agent or combination of agents capable of killing fungi and/or inhibiting fungal growth.

As used herein, the term “insecticide(s)” means any agent or combination of agents capable of killing one or more insects and/or inhibiting the growth of one or more insects.

As used herein, the term “nematicide(s)” means any agent or combination of agents capable of killing one or more nematodes and/or inhibiting the growth of one or more nematodes.

As used herein, the term “acaricide(s)” means any agent or combination of agents capable of killing one or more acarids and/or inhibiting the growth of one or more acarids.

As used herein, term “enhanced plant growth” means increased plant yield (e.g., increased biomass, increased fruit number, increased boll number, or a combination thereof that may be measured by bushels per acre), increased root number, increased root mass, increased root volume, increased leaf area, increased plant stand, increased plant vigor, faster seedling emergence (i.e., enhanced emergence), faster germination, (i.e., enhanced germination), or combinations thereof.

As used herein, the terms “plant(s)” and “plant part(s)” means all plants and plant populations such as desired and undesired wild plants or crop plants (including naturally occurring crop plants). Crop plants can be plants, which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material and vegetative and generative propagation material (e.g., cuttings, tubers, rhizomes, off-shoots and seeds, etc.).

As used herein, the term “foliage” means all parts and organs of plants above the ground. Non-limiting examples include leaves, needles, stalks, stems, flowers, fruit bodies, fruits, etc. As used herein, the term “foliar application”, “foliarly applied”, and variations thereof, means application of an active ingredient to the foliage or above ground portions of the plant, (e.g., the leaves of the plant). Application may be effected by any means known in the art (e.g., spraying the active ingredient).

As used herein, the term “inoculum” means any form of microbial cells, or spores, which is capable of propagating on or in the soil when the conditions of temperature, moisture, etc., are favorable for microbial growth.

As used herein, the term “nitrogen fixing organism(s)” means any organism capable of converting atmospheric nitrogen (N₂) into ammonia (NH₃).

As used herein, the term “phosphate solubilizing organism” means any organism capable of converting insoluble phosphate into a soluble phosphate form.

As used herein, the terms “spore” has its normal meaning which is well known and understood by those of skill in the art. As used herein, the term spore means a microorganism in its dormant, protected state.

As used herein, the term “source” of a particular element means a compound of that element which, at least in the soil conditions under consideration, does not make the element fully available for plant uptake.

### Compositions

The compositions disclosed comprise a carrier and one or more flavonoids as described herein. In certain embodiments, the composition may be in the form of a liquid, a gel, a slurry, a solid, or a powder (wettable powder or dry powder). In a particular embodiment, the composition is a liquid composition. Liquid compositions, as described herein, may be suitable for foliar application to a plant or plant part.

### Flavonoids:

As disclosed throughout, the compositions described herein comprise one or more flavonoids. Flavonoid compounds are commercially available, e.g., from Novozymes BioAg, Saskatoon, Canada; Natland International Corp., Research Triangle Park, N.C.; MP Biomedicals, Irvine, Calif.; LC Laboratories, Woburn Mass. Flavonoid compounds may be isolated from plants or seeds, e.g., as described in U.S. Pat. Nos. 5,702,752; 5,990,291; and 6,146,668. Flavonoid compounds may also be produced by genetically engineered organisms, such as yeast, as described in Ralston, et al., Plant Physiology 137:1375-88 (2005). Flavonoid compounds are intended to include all flavonoid compounds as well as isomers, salts, and solvates thereof.

The one or more flavonoids may be a natural flavonoid (i.e., not synthetically produced), a synthetic flavonoid (e.g., a chemically synthesized flavonoid) or a combination thereof. In a particular embodiment, the compositions described herein comprise a flavanol, a flavone, an anthocyanidin, an isoflavonoid, a neoflavonoid and combinations thereof, including all isomer, solvate, hydrate, polymorphic, crystalline form, non-crystalline form, and salt variations thereof.

In an embodiment, the compositions described herein comprise one or more flavanols. In still another embodiment, the compositions described herein comprise one or more flavanols selected from the group consisting of flavan-3-ols (e.g., catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), etc.), flavan-4-ols, flavan-3,4-diols (e.g., leucoanthocyanidin), proanthocyanidins (e.g., includes dimers, trimer, oligomers, or polymers of flavanols), and combinations thereof. In still yet another embodiment, the compositions comprise one or more flavanols selected from the group consisting of catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), flavan-4-ol, leucoanthocyanidin, and dimers, trimers, olilgomers or polymers thereof.

In another embodiment, the compositions described herein comprise one or more flavones. In still another embodiment, the compositions described herein comprise one or more flavones selected from the group consisting of flavones (e.g., luteolin, apigenin, tangeritin, etc.), flavonols (e.g., quercetin, quercitrin, rutin, kaempferol, kaempferitrin, astragalin, sophoraflavonoloside, myricetin, fisetin, isorhamnetin, pachypodol, rhamnazin, etc.), flavanones (e.g. hesperetin, hesperidin, naringenin, eriodictyol, homoeriodictyol, etc.), and flavanonols (e.g., dihydroquercetin, dihydrokaempferol, etc.). In still yet another embodiment, the compositions comprise one or more flavones selected from the group consisting of luteolin, apigenin, tangeritin, quercetin, quercitrin, rutin, kaempferol, kaempferitrin, astragalin, sophoraflavonoloside, myricetin, fisetin, isorhamnetin, pachypodol, rhamnazin, hesperetin, hesperidin, naringenin, eriodictyol, homoeriodictyol, dihydroquercetin, dihydrokaempferol, and combinations thereof.

In still another embodiment, the compositions described herein comprise one or more anthocyanidins. In yet another embodiment, the compositions described herein comprise one or more anthocyanidins selected from the group selected from the group consisting of cyanidins, delphinidins, malvidins, pelargonidins, peonidins, petunidins, and combinations thereof.

In another embodiment, the compositions described herein comprise one or more isoflavonoids. In still yet another embodiment, the compositions described herein comprise one or more isoflavonoids selected from the group consisting of phytoestrogens, isoflavones (e.g., genistein, daidzein, glycitein, etc.), and isoflavanes (e.g., equol, lonchocarpane, laxiflorane, etc.), and combinations thereof. In yet another embodiment the compositions comprise one or more isoflavonoids selected from the group consisting of genistein, daidzein, glycitein, equol, lonchocarpane, laxiflorane, and combinations thereof.

In another embodiment, the compositions described herein comprise one or more neoflavonoids. In yet another embodiment, the compositions described herein comprise one or more neoflavonoids selected from the group consisting of neoflavones (e.g., calophyllolide), neoflavenes (e.g., dalbergichromene), coutareagenins, dalbergins, nivetins, and combinations thereof. In still yet another embodiment, the compositions described herein comprise one or more neoflavonoids selected from the group consisting of calophyllolide, dalbergichromene, coutareagenin, dalbergin, nivetin, and combinations thereof.

In another embodiment, the compositions described herein comprise one or more flavonoids selected from the group consisting of catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), flavan-4-ol, leucoanthocyanidin, proanthocyanidins, luteolin, apigenin, tangeritin, quercetin, quercitrin, rutin, kaempferol, kaempferitrin, astragalin, sophoraflavonoloside, myricetin, fisetin, isorhamnetin, pachypodol, rhamnazin, hesperetin, hesperidin, naringenin, eriodictyol, homoeriodictyol, dihydroquercetin, dihydrokaempferol, cyanidins, delphinidins, malvidins, pelargonidins, peonidins, petunidins, genistein, daidzein, glycitein, equol, lonchocarpane, laxiflorane, calophyllolide, dalbergichromene, coutareagenin, dalbergin, nivetin, and combinations thereof. In still another embodiment, the compositions described herein comprise one or more flavonoids selected from the group consisting of hesperetin, hesperidin, naringenin, genistein, daidzein, and combinations thereof. In a particular embodiment, the composition described herein comprises the flavonoid hesperetin. In another particular embodiment, the composition described herein comprises the flavonoid hesperidin. In still another particular embodiment, the composition described herein comprises the flavonoid naringenin. In still yet another particular embodiment, the composition described herein comprises the flavonoid genistein. In yet still another particular embodiment, the composition described herein comprises the flavonoid daidzein.

In a more particular embodiment, the compositions disclosed herein comprise the flavonoids genistein and daidzein, wherein the ratio between genistein and daidzein is 1:10 to 10:1. In a particular aspect, the ratio between genistein and daidzein is 8:2 to 1:1. In a more particular embodiment, the compositions disclosed herein comprise the flavonoids hesperitin and naringenin, wherein the ratio between hesperitin and naringenin is 1:10 to 10:1. In a particular aspect, the ratio between hesperitin and naringenin is 7:3 to 10:1. In a more particular embodiment, the compositions disclosed herein comprise the flavonoids genistein, daidzein, hesperitin, and naringenin, wherein the ratio between genistein to daidzein to hesperitin to naringenin is 1:10:10:10 to 10:1:1:1. In a particular embodiment, the ratio between genistein to daidzein to hesperitin to naringenin is 1:1:1:1. In still another particular embodiment, the compositions described herein are a 50:50 blend of genistein and daidzein and hesperitin and naringenin wherein the ratio genistein and daidzein is 8:2 and the ratio between hesperitin and naringenin is 7:3.

### Carriers:

The carriers described herein will allow the one or more flavonoids(s) to remain efficacious (e.g., capable of increasing plant growth). Non-limiting examples of carriers described herein include liquids, gels, slurries, or solids (including wettable powders or dry powders). The selection of the carrier material will depend on the intended application. The carrier may, for example, be a soil-compatible carrier, a seed-compatible carrier, and/or a foliar-compatible carrier. In a particular embodiment, the carrier is a foliar-compatible carrier.

In one embodiment, the carrier is a liquid carrier. Non-limiting examples of liquids useful as carriers for the compositions disclosed herein include water, an aqueous solution, or a non-aqueous solution. In another embodiment the carrier is an organic solvent. In another embodiment the carrier is an aqueous solution. In another embodiment, the carrier is a non-aqueous solution. In a particular embodiment the carrier is water. In a further particular embodiment the carrier is N-methyl-2-pyrrolidone (hereinafter referred to as NMP). In still another embodiment, the carrier is dimethyl sulfoxide (hereinafter referred to as DMSO). In still a further embodiment, the carrier is an aqueous solution comprising water and NMP. In yet a further embodiment, the carrier is an aqueous solution comprising water and DMSO. In yet still a further embodiment, the carrier is an aqueous solution comprising water, NMP, and DMSO. In another embodiment, the carrier is a non-aqueous solution comprising NMP and DMSO.

If a liquid carrier is used, the liquid carrier may further include growth media to culture one or more microbial strains used in the compositions described. Non-limiting examples of suitable growth media for microbial strains include YEM media, mannitol yeast extract, glycerol yeast extract, Czapek-Dox medium, potato dextrose broth, or any media known to those skilled in the art to be compatible with, and/or provide growth nutrients to microbial strain which may be included to the compositions described herein.

In particular embodiments, the one or more flavonoids are added to the carrier at a concentration of 0.01-10.0 g/L. In another embodiment, the one or more flavonoids are added to the carrier at a concentration of 0.01-9.5 g/L. In still another embodiment, the one or more flavonoids are added to the carrier at a concentration of 0.01-9.0 g/L. In still another embodiment, the one or more flavonoids are added to the carrier at a concentration of 0.01-8.5 g/L. In still another embodiment, the one or more flavonoids are added to the carrier at a concentration of 0.01-8.0 g/L. In still another embodiment, the one or more flavonoids are added to the carrier at a concentration of 0.01-7.5 g/L. In still another embodiment, the one or more flavonoids are added to the carrier at a concentration of 0.01-7.0 g/L. In still another embodiment, the one or more flavonoids are added to the carrier at a concentration of 0.01-6.5 g/L. In still another embodiment, the one or more flavonoids are added to the carrier at a concentration of 0.01-6.0 g/L. In still another embodiment, the one or more flavonoids are added to the carrier at a concentration of 0.01-5.5 g/L. In still another embodiment, the one or more flavonoids are added to the carrier at a concentration of 0.01-5.0 g/L. In still another embodiment, the one or more flavonoids are added to the carrier at a concentration of 0.01-4.5 g/L. In still another embodiment, the one or more flavonoids are added to the carrier at a concentration of 0.01-4.0 g/L. In still another embodiment, the one or more flavonoids are added to the carrier at a concentration of 0.01-3.5 g/L. In still another embodiment, the one or more flavonoids are added to the carrier at a concentration of 0.01-3.0 g/L. In still another embodiment, the one or more flavonoids are added to the carrier at a concentration of 0.01-2.5 g/L. In still another embodiment, the one or more flavonoids are added to the carrier at a concentration of 0.01-2.0 g/L. In still another embodiment, the one or more flavonoids are added to the carrier at a concentration of 0.01-1.75 g/L. In still another embodiment, the one or more flavonoids are added to the carrier at a concentration of 0.01-1.50 g/L. In still another embodiment, the one or more flavonoids are added to the carrier at a concentration of 0.01-1.25 g/L. In still another embodiment, the one or more flavonoids are added to the carrier at a concentration of 0.01-1.125 g/L. In still another embodiment, the one or more flavonoids are added to the carrier at a concentration of 0.01-1.0 g/L. In still another embodiment, the one or more flavonoids are added to the carrier at a concentration of 0.01-0.75 g/L. In still another embodiment, the one or more flavonoids are added to the carrier at a concentration of 0.01-0.50 g/L. In still another embodiment, the one or more flavonoids are added to the carrier at a concentration of 0.01-0.25 g/L. In still another embodiment, the one or more flavonoids are added to the water carrier at a concentration of 0.01-0.125 g/L. In still yet another embodiment, the one or more flavonoids are added to the carrier at a concentration of 0.01-0.10 g/L.

In another embodiment, the one or more flavonoids are part of a concentrated composition. In one embodiment, the one or more flavonoids are added to the carrier at a concentration of 1.0-40.0 g/L. In another embodiment, the one or more flavonoids are added to the carrier at a concentration of 1.0-35.0 g/L. In still another embodiment, the one or more flavonoids are added to the carrier at a concentration of 1.0-30.0 g/L. In still another embodiment, the one or more flavonoids are added to the carrier at a concentration of 1.0-25.0 g/L. In still another embodiment, the one or more flavonoids are added to the carrier at a concentration of 1.0-20.0 g/L. In still another embodiment, the one or more flavonoids are added to the carrier at a concentration of 1.0-15.0 g/L. In still another embodiment, the one or more flavonoids are added to the carrier at a concentration of 1.0-12.5 g/L. In still another embodiment, the one or more flavonoids are added to the carrier at a concentration of 1.0-12.0. In still another embodiment, the one or more flavonoids are added to the carrier at a concentration of 1.0-11.5 g/L. In still another embodiment, the one or more flavonoids are added to the carrier at a concentration of 1.0-11.0 g/L. In still another embodiment, the one or more flavonoids are added to the carrier at a concentration of 1.0-10.5 g/L. In still another embodiment, the one or more flavonoids are added to the carrier at a concentration of 1.0-10.0 g/L. In still another embodiment, the one or more flavonoids are added to the carrier at a concentration of 1.0-9.5 g/L. In still another embodiment, the one or more flavonoids are added to the carrier at a concentration of 1.0-9.0 g/L. In still another embodiment, the one or more flavonoids are added to the carrier at a concentration of 1.0-8.5 g/L. In still another embodiment, the one or more flavonoids are added to the carrier at a concentration of 1.0-8.0 g/L. In still another embodiment, the one or more flavonoids are added to the carrier at a concentration of 1.0-7.5 g/L. In still another embodiment, the one or more flavonoids are added to the carrier at a concentration of 1.0-7.0 g/L. In still another embodiment, the one or more flavonoids are added to the carrier at a concentration of 1.0-6.5 g/L. In still another embodiment, the one or more flavonoids are added to the carrier at a concentration of 1.0-6.0 g/L. In still another embodiment, the one or more flavonoids are added to the carrier at a concentration of 1.0-5.5 g/L. In still another embodiment, the one or more flavonoids are added to the carrier at a concentration of 1.0-5.0 g/L. In still another embodiment, the one or more flavonoids are added to the carrier at a concentration of 1.0-4.5 g/L. In still another embodiment, the one or more flavonoids are added to the carrier at a concentration of 1.0-4.0 g/L. In still another embodiment, the one or more flavonoids are added to the carrier at a concentration of 1.0-3.5 g/L. In still another embodiment, the one or more flavonoids are added to the water carrier at a concentration of 1.0-3.0 g/L. In still yet another embodiment, the one or more flavonoids are added to the carrier at a concentration of 1.0-2.5 g/L. In still another embodiment, the one or more flavonoids are added to the carrier at a concentration of 1.0-2.0 g/L. In still another embodiment, the one or more flavonoids are added to the carrier at a concentration of 1.0-1.75 g/L. In still another embodiment, the one or more flavonoids are added to the carrier at a concentration of 1.0-1.5 g/L. In still another embodiment, the one or more flavonoids are added to the carrier at a concentration of 1.0-1.25 g/L. In yet still another embodiment, the one or more flavonoids are added to the water carrier at a concentration of 1.0-1.1 g/L.

### Agriculturally Beneficial Ingredients:

The compositions disclosed herein may comprise one or more agriculturally beneficial ingredients. Non-limiting examples of agriculturally beneficial ingredients include one or more biologically active ingredients, nutrients, biostimulants, preservatives, polymers, wetting agents, surfactants, herbicides, fungicides, insecticides, or combinations thereof.

Biologically Active Ingredient(s):

The compositions described herein may optionally include one or more biologically active ingredients as described herein, other than the one or more flavonoids described herein. Non-limiting examples of biologically active ingredients include plant signal molecules (e.g., lipo-chitooligosaccharides (LCO), chitooligosaccharides (CO), chitinous compounds, jasmonic acid or derivatives thereof, linoleic acid or derivatives thereof, linolenic acid or derivatives thereof, karrikins, etc.) and beneficial microorganisms (e.g., Rhizobium spp., Bradyrhizobium spp., Sinorhizobium spp., Azorhizobium spp., Glomus spp., Gigaspora spp., Hymenoscyphous spp., Oidiodendron spp., Laccaria spp., Pisolithus spp., Rhizopogon spp., Scleroderma spp., Rhizoctonia spp., Acinetobacter spp., Arthrobacter spp., Arthrobotrys spp., Aspergillus spp., Azospirillum spp, Bacillus spp, Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., etc.).

Plant Signal Molecule(s):

In an embodiment, the compositions described herein include one or more plant signal molecules. In one embodiment, the one or more plant signal molecules are one or more LCOs. In another embodiment, the one or more plant signal molecules are one or more COs. In still another embodiment, the one or more plant signal molecules are one or more chitinous compounds. In yet another embodiment, the one or more plant signal molecules are one or more non-flavonoid nod gene inducers (e.g., jasmonic acid, linoleic acid, linolenic acid, and derivatives thereof). In still yet another embodiment, the one or more plant signal molecules are one or more karrikins or derivatives thereof. In still another embodiment, the one or more plant signal molecules are one or more LCOs, one or more COs, one or more chitinous compounds, one or more non-flavonoid nod gene inducers and derivatives thereof, one or more karrikins and derivatives thereof, or any signal molecule combination thereof.

LCOs:

Lipo-chitooligosaccharide compounds (LCOs), also known in the art as symbiotic Nod signals or Nod factors, consist of an oligosaccharide backbone of β-1,4-linked N-acetyl-D-glucosamine (“GlcNAc”) residues with an N-linked fatty acyl chain condensed at the non-reducing end. LCO's differ in the number of GlcNAc residues in the backbone, in the length and degree of saturation of the fatty acyl chain, and in the substitutions of reducing and non-reducing sugar residues. LCOs are intended to include all LCOs as well as isomers, salts, and solvates thereof. An example of an LCO is presented below as formula I:

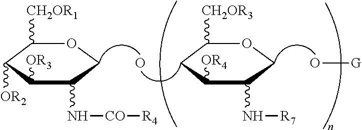

in which:

G is a hexosamine which can be substituted, for example, by an acetyl group on the nitrogen, a sulfate group, an acetyl group and/or an ether group on an oxygen,

R₁, R₂, R₃, R₅, R₆ and R₇, which may be identical or different, represent H, CH₃CO—, Cₓ H_{y} CO— where x is an integer between 0 and 17, and y is an integer between 1 and 35, or any other acyl group such as for example a carbamyl,

R₄ represents a mono-, di-, tri- and tetraunsaturated aliphatic chain containing at least 12 carbon atoms, and n is an integer between 1 and 4.

LCOs may be obtained (isolated and/or purified) from bacteria such as Rhizobia, e.g., Rhizobium spp., Bradyrhizobium spp., Sinorhizobium spp. and Azorhizobium spp. LCO structure is characteristic for each such bacterial species, and each strain may produce multiple LCO's with different structures. For example, specific LCOs from S. meliloti have also been described in U.S. Pat. No. 5,549,718 as having the formula II:

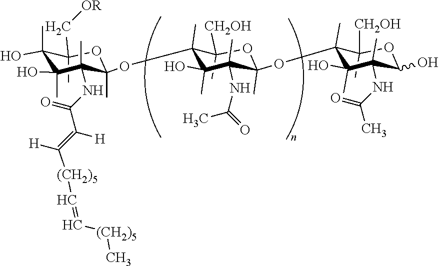

in which R represents H or CH₃CO— and n is equal to 2 or 3.

Even more specific LCOs include NodRM, NodRM-1, NodRM-3. When acetylated (the R═CH₃CO—), they become AcNodRM-1, and AcNodRM-3, respectively (U.S. Pat. No. 5,545,718).

LCOs from Bradyrhizobium japonicum are described in U.S. Pat. Nos. 5,175,149 and 5,321,011. Broadly, they are pentasaccharide phytohormones comprising methylfucose. A number of these B. japonicum-derived LCOs are described: BjNod-V (C_{18:1}); BjNod-V (A_{C}, C_{18:1}), BjNod-V (C_{16:1}); and BjNod-V (A_{C}, C_{16:0}), with “V” indicating the presence of five N-acetylglucosamines; “Ac” an acetylation; the number following the “C” indicating the number of carbons in the fatty acid side chain; and the number following the “:” the number of double bonds.

LCOs used in compositions of the disclosure may be obtained (i.e., isolated and/or purified) from bacterial strains that produce LCO's, such as strains of Azorhizobium, Bradyrhizobium (including B. japonicum), Mesorhizobium, Rhizobium (including R. leguminosarum), Sinorhizobium (including S. meliloti), and bacterial strains genetically engineered to produce LCO's.

Also encompassed by the present disclosureare compositions using LCOs obtained (i.e., isolated and/or purified) from a mycorrhizal fungus, such as fungi of the group Glomerocycota, e.g., Glomus intraradicus. The structures of representative LCOs obtained from these fungi are described in WO 2010/049751 and WO 2010/049751 (the LCOs described therein also referred to as “Myc factors”).

Further encompassed by compositions of the present disclosure is use of synthetic LCO compounds, such as those described in WO 2005/063784, and recombinant LCO's produced through genetic engineering. The basic, naturally occurring LCO structure may contain modifications or substitutions found in naturally occurring LCO's, such as those described in Spaink, Crit. Rev. Plant Sci. 54:257-288 (2000) and D'Haeze, et al., Glycobiology 12:79R-105R (2002). Precursor oligosaccharide molecules (COs, which as described below, are also useful as plant signal molecules in the present disclosure) for the construction of LCOs may also be synthesized by genetically engineered organisms, e.g., as in Samain, et al., Carb. Res. 302:35-42 (1997); Samain, et al., J. Biotechnol. 72:33-47 (1999).

LCO's may be utilized in various forms of purity and may be used alone or in the form of a culture of LCO-producing bacteria or fungi. Methods to provide substantially pure LCO's include simply removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC, and the purified LCO molecules can be freeze-dried for long-term storage.

COs:

Chitooligosaccharides (COs) are known in the art as β-1-4 linked N actyl glucosamine structures identified as chitin oligomers, also as N-acetylchitooligosaccharides. CO's have unique and different side chain decorations which make them different from chitin molecules [(C₈H₁₃NO₅)n, CAS No. 1398-61-4], and chitosan molecules [(C₅H₁₁NO₄)n, CAS No. 9012-76-4]. Representative literature describing the structure and production of COs is as follows: Van der Hoist, et al., Current Opinion in Structural Biology, 11:608-616 (2001); Robina, et al., Tetrahedron 58:521-530 (2002); Hanel, et al., Planta 232:787-806 (2010); Rouge, et al. Chapter 27, “The Molecular Immunology of Complex Carbohydrates” in Advances in Experimental Medicine and Biology, Springer Science; Wan, et al., Plant Cell 21:1053-69 (2009); PCT/F100/00803 (Sep. 21, 2000); and Demont-Caulet, et al., Plant Physiol. 120(1):83-92 (1999). The COs may be synthetic or recombinant. Methods for preparation of recombinant COs are known in the art. See, e.g., Samain, et al. (supra.); Cottaz, et al., Meth. Eng. 7(4):311-7 (2005) and Samain, et al., J. Biotechnol. 72:33-47 (1999). COs are intended to include isomers, salts, and solvates thereof.

Chitinous Compounds:

Chitins and chitosans, which are major components of the cell walls of fungi and the exoskeletons of insects and crustaceans, are also composed of GlcNAc residues. Chitinous compounds include chitin, (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxymethyl)oxan-3-yl]methoxymethyl]-4-hydroxy-6-(hydroxymethyl)oxan-3-ys]ethanamide), chitosan, (IUPAC: 5-amino-6-[5-amino-6-[5-amino-4,6-dihydroxy-2-(hydroxymethyl)oxan-3-yl]oxy-4-hydroxy-2-(hydroxymethyl)oxan-3-yl]oxy-2(hydroxymethyl)oxane-3,4-diol), and isomers, salts, and solvates thereof.

These compounds may be obtained commercially, e.g., from Sigma-Aldrich, or prepared from insects, crustacean shells, or fungal cell walls. Methods for the preparation of chitin and chitosan are known in the art, and have been described, for example, in U.S. Pat. No. 4,536,207 (preparation from crustacean shells), Pochanavanich, et al., Lett. Appl. Microbiol. 35:17-21 (2002) (preparation from fungal cell walls), and U.S. Pat. No. 5,965,545 (preparation from crab shells and hydrolysis of commercial chitosan). Deacetylated chitins and chitosans may be obtained that range from less than 35% to greater than 90% deacetylation, and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulated for seed treatment are also commercially available. Commercial products include, for example, ELEXA® (Plant Defense Boosters, Inc.) and BEYOND™ (Agrihouse, Inc.).

Non-Flavonoid Nod-Gene Inducer(s):

Jasmonic acid (JA, [1R-[1α,2β(Z)]]-3-oxo-2-(pentenyl)cyclopentaneacetic acid) and its derivatives, linoleic acid ((Z,Z)-9,12-Octadecadienoic acid) and its derivatives, and linolenic acid ((Z,Z,Z)-9,12,15-octadecatrienoic acid) and its derivatives, may also be used in the compositions described herein. Non-flavonoid nod-gene inducers are intended to include not only the non-flavonoid nod-gene inducers described herein, but isomers, salts, and solvates thereof.

Jasmonic acid and its methyl ester, methyl jasmonate (MeJA), collectively known as jasmonates, are octadecanoid-based compounds that occur naturally in plants. Jasmonic acid is produced by the roots of wheat seedlings, and by fungal microorganisms such as Botryodiplodia theobromae and Gibberella fujikuroi, yeast (Saccharomyces cerevisiae), and pathogenic and non-pathogenic strains of Escherichia coli. Linoleic acid and linolenic acid are produced in the course of the biosynthesis of jasmonic acid. Jasmonates, linoleic acid and linoleic acid (and their derivatives) are reported to be inducers of nod gene expression or LCO production by rhizobacteria. See, e.g., Mabood, Fazli, Jasmonates induce the expression of nod genes in Bradyrhizobium japonicum, May 17, 2001; and Mabood, Fazli, “Linoleic and linolenic acid induce the expression of nod genes in Bradyrhizobium japonicum,” USDA 3, May 17, 2001.

Useful derivatives of linoleic acid, linolenic acid, and jasmonic acid that may be useful in compositions of the present disclosure include esters, amides, glycosides and salts. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are independently: hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent such as dicyclohexyl carbodiimide (DCC), under neutral conditions. Suitable salts of linoleic acid, linolenic acid, and jasmonic acid include e.g., base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing together a solution of linoleic acid, linolenic acid, or jasmonic acid with a solution of the base. The salt may be precipitated from solution and be collected by filtration or may be recovered by other means such as by evaporation of the solvent.

Karrikin(s):

Karrikins are vinylogous 4H-pyrones e.g., 2H-furo[2,3-c]pyran-2-ones including derivatives and analogues thereof. It is intended that the karrikins include isomers, salts, and solvates thereof. Examples of these compounds are represented by the following structure:

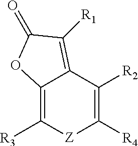

wherein; Z is O, S or NR₅; R₁, R₂, R₃, and R₄ are each independently H, alkyl, alkenyl, alkynyl, phenyl, benzyl, hydroxy, hydroxyalkyl, alkoxy, phenyloxy, benzyloxy, CN, COR₅, COOR═, halogen, NR₆R₇, or NO₂; and R₅, R₆, and R₇ are each independently H, alkyl or alkenyl, or a biologically acceptable salt thereof. Examples of biologically acceptable salts of these compounds may include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts may include alkali metal salts, with bases, examples of which include the sodium and potassium salts. Examples of compounds embraced by the structure and which may be suitable for use in the present disclosure include the following: 3-methyl-2H-furo[2,3-c]pyran-2-one (where R₁═CH₃, R₂, R₃, R₄═H), 2H-furo[2,3-c]pyran-2-one (where R₁, R₂, R₃, R4=H), 7-methyl-2H-furo[2,3-c]pyran-2-one (where R₁, R₂, R₄═H, R₃═CH₃), 5-methyl-2H-furo[2,3-c]pyran-2-one (where R₁, R₂, R₃═H, R₄═CH₃), 3,7-dimethyl-2H-furo[2,3-c]pyran-2-one (where R₁, R₃═CH₃, R₂, R₄═H), 3,5-dimethyl-2H-furo[2,3-c]pyran-2-one (where R₁, R₄═CH₃, R₂, R₃═H), 3,5,7-trimethyl-2H-furo[2,3-c]pyran-2-one (where R₁, R₃, R₄═CH₃, R₂═H), 5-methoxymethyl-3-methyl-2H-furo[2,3-c]pyran-2-one (where R₁═CH₃, R₂, R₃═H, R₄═CH₂OCH₃), 4-bromo-3,7-dimethyl-2H-furo[2,3-c]pyran-2-one (where R₁, R₃═CH₃, R₂═Br, R₄═H), 3-methylfuro[2,3-c]pyridin-2(3H)-one (where Z═NH, R₁═CH₃, R₂, R₃, R₄═H), 3,6-dimethylfuro[2,3-c]pyridin-2(6H)-one (where Z═N—CH₃, R₁═CH₃, R₂, R₃, R₄═H). See, U.S. Pat. No. 7,576,213. These molecules are also known as karrikins. See, Halford, “Smoke Signals,” in Chem. Eng. News (Apr. 12, 2010), at pages 37-38 (reporting that karrikins or butenolides which are contained in smoke act as growth stimulants and spur seed germination after a forest fire, and can invigorate seeds such as corn, tomatoes, lettuce and onions that had been stored). These molecules are the subject of U.S. Pat. No. 7,576,213.

Beneficial Microorganism(s):

In an embodiment, the compositions described herein may optionally include one or more beneficial microorganisms. The one or more beneficial microorganisms may be in a spore form, a vegetative form, or a combination thereof. The one or more beneficial microorganisms may include any number of microorganisms having one or more beneficial properties (e.g., produce one or more of the plant signal molecules described herein, enhance nutrient and water uptake, promote and/or enhance nitrogen fixation, enhance growth, enhance seed germination, enhance seedling emergence, break the dormancy or quiescence of a plant, provide anti-fungal activity, etc.).

In one embodiment, the one or more beneficial microorganisms are diazotrophs (i.e., bacteria which are symbiotic nitrogen-fixing bacteria). In still another embodiment, the one or more beneficial microorganisms are bacterial diazotrophs selected from the genera Rhizobium spp., Bradyrhizobium spp., Azorhizobium spp., Sinorhizobium spp., Mesorhizobium spp., Azospirillum spp., and combinations thereof. In still another embodiment, the one or more beneficial microorganisms are bacteria selected from the group consisting of Rhizobium cellulosilyticum, Rhizobium daejeonense, Rhizobium etli, Rhizobium galegae, Rhizobium gallicum, Rhizobium giardinii, Rhizobium hainanense, Rhizobium huautlense, Rhizobium indigoferae, Rhizobium leguminosarum, Rhizobium loessense, Rhizobium lupini, Rhizobium lusitanum, Rhizobium meliloti, Rhizobium mongolense, Rhizobium miluonense, Rhizobium sullae, Rhizobium tropici, Rhizobium undicola, Rhizobium yanglingense, Bradyrhizobium bete, Bradyrhizobium canariense, Bradyrhizobium elkanii, Bradyrhizobium iriomotense, Bradyrhizobium japonicum, Bradyrhizobium jicamae, Bradyrhizobium liaoningense, Bradyrhizobium pachyrhizi, Bradyrhizobium yuanmingense, Azorhizobium caulinodans, Azorhizobium doebereinerae, Sinorhizobium abri, Sinorhizobium adhaerens, Sinorhizobium americanum, Sinorhizobium aboris Sinorhizobium fredii, Sinorhizobium indiaense, Sinorhizobium kostiense, Sinorhizobium kummerowiae, Sinorhizobium medicae, Sinorhizobium meliloti, Sinorhizobium mexicanus, Sinorhizobium morelense, Sinorhizobium saheli, Sinorhizobium terangae, Sinorhizobium xinjiangense, Mesorhizobium albiziae, Mesorhizobium amorphae, Mesorhizobium chacoense, Mesorhizobium ciceri, Mesorhizobium huakuii, Mesorhizobium loti, Mesorhizobium mediterraneum, Mesorhizobium pluifarium, Mesorhizobium septentrionale, Mesorhizobium ternperatum, Mesorhizobium tianshanense, Azospirillum amazonense, Azospirillum brasilense, Azospirillum canadense, Azospirillum doebereinerae, Azospirillum formosense, Azospirillum halopraeferans, Azospirillum irakense, Azospirillum largimobile, Azospirillum lipoferum, Azospirillum melinis, Azospirillum oryzae, Azospirillum picis, Azospirillum rugosum, Azospirillum thiophilum, Azospirillum zeae, and combinations thereof.

In a particular embodiment, the beneficial microorganism is a bacterial daizotroph selected from the group consisting of Bradyrhizobium japonicum, Rhizobium leguminosarum, Rhizobium meliloti, Sinorhizobium meliloti, Azospirillum brasilense, and combinations thereof. In another embodiment, the beneficial microorganism is the bacterial daizotroph Bradyrhizobium japonicum. In another embodiment, the beneficial microorganism is the bacterial daizotroph Rhizobium leguminosarum. In another embodiment, the beneficial microorganism is the bacterial daizotroph Rhizobium meliloti. In another embodiment, the beneficial microorganism is the bacterial daizotroph Sinorhizobium meliloti. In another embodiment, the beneficial microorganism is the bacterial daizotroph Azospirillum brasilense.

In a particular embodiment, the one or more diazotrophs comprises one or more strains of Rhizobium leguminosarum. In another particular embodiment, the strain of R. leguminosarum comprises the strain SO12A-2-(IDAC 080305-01). In another particular embodiment, the one or more diazotrophs comprises a strain of Bradyrhizobium japonicum. In still another particular embodiment, the strain of Bradyrhizobium japonicum comprises the strain B. japonicum USDA 532C, B. japonicum USDA 110, B. japonicum USDA 123, B. japonicum USDA 127, B. japonicum USDA 129, B. japonicum NRRL α-50608, B. japonicum NRRL B-50609, B. japonicum NRRL B-50610, B. japonicum NRRL B-50611, B. japonicum NRRL B-50612, B. japonicum NRRL B-50592 (deposited also as NRRL B-59571), B. japonicum NRRL B-50593 (deposited also as NRRL B-59572), B. japonicum NRRL B-50586 (deposited also as NRRL B-59565), B. japonicum NRRL B-50588 (deposited also as NRRL B-59567), B. japonicum NRRL B-50587 (deposited also as NRRL B-59566), B. japonicum NRRL B-50589 (deposited also as NRRL B-59568), B. japonicum NRRL B-50591 (deposited also as NRRL B-59570), B. japonicum NRRL B-50590 (deposited also as NRRL B-59569), NRRL B-50594 (deposited also as NRRL B-50493), B. japonicum NRRL B-50726, B. japonicum NRRL B-50727, B. japonicum NRRL B-50728, B. japonicum NRRL B-50729, B. japonicum NRRL B-50730, and combinations thereof.

In still yet a more particular embodiment, the one or more diazotrophs comprises one or more strains of R. leguminosarum comprises the strain SO12A-2-(IDAC 080305-01), B. japonicum USDA 532C, B. japonicum USDA 110, B. japonicum USDA 123, B. japonicum USDA 127, B. japonicum USDA 129, B. japonicum NRRL B-50608, B. japonicum NRRL B-50609, B. japonicum NRRL B-50610, B. japonicum NRRL B-50611, B. japonicum NRRL B-50612, B. japonicum NRRL B-50592 (deposited also as NRRL B-59571), B. japonicum NRRL B-50593 (deposited also as NRRL B-59572), B. japonicum NRRL B-50586 (deposited also as NRRL B-59565), B. japonicum NRRL B-50588 (deposited also as NRRL B-59567), B. japonicum NRRL B-50587 (deposited also as NRRL B-59566), B. japonicum NRRL B-50589 (deposited also as NRRL B-59568), B. japonicum NRRL B-50591 (deposited also as NRRL B-59570), B. japonicum NRRL B-50590 (deposited also as NRRL B-59569), NRRL B-50594 (deposited also as NRRL B-50493), B. japonicum NRRL B-50726, B. japonicum NRRL B-50727, B. japonicum NRRL B-50728, B. japonicum NRRL B-50729, B. japonicum NRRL B-50730, and combinations thereof.

In another embodiment, the one or more beneficial microorganisms comprise one or more phosphate solubilizing microorganisms. Phosphate solubilizing microorganisms include fungal and bacterial strains. In an embodiment, the phosphate solubilizing microorganism are microorganisms selected from the genera consisting of Acinetobacter spp., Arthrobacter spp, Arthrobotrys spp., Aspergillus spp., Azospirillum spp., Bacillus spp., Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., and combinations thereof. In still yet another embodiment, the phosphate solubilizing microorganism is a microorganism selected from the group consisting of Acinetobacter calcoaceticus, Arthrobotrys oligospora, Aspergillus niger, Azospirillum amazonense, Azospirillum brasilense, Azospirillum canadense, Azospirillum doebereinerae, Azospirillum formosense, Azospirillum halopraeferans, Azospirillum irakense, Azospirillum largimobile, Azospirillum lipoferum, Azospirillum melinis, Azospirillum oryzae, Azospirillum picis, Azospirillum rugosum, Azospirillum thiophilum, Azospirillum zeae, Bacillus amyloliquefaciens, Bacillus atrophaeus, Bacillus circulans, Bacillus licheniformis, Bacillus subtilis, Burkholderia cepacia, Burkholderia vietnamiensis, Candida krissii, Chryseomonas luteola, Enterobacter aerogenes, Enterobacter asburiae, Enterobacter taylorae, Eupenicillium parvum, Kluyvera cryocrescens, Mucor ramosissimus, Paecilomyces hepialid, Paecilomyces marquandii, Paenibacillus macerans, Paenibacillus mucilaginosus, Penicillium bilaiae (formerly known as Penicillium bilaii), Penicillium albidum, Penicillium aurantiogriseum, Penicillium chrysogenum, Penicillium citreonigrum, Penicillium citrinum, Penicillium digitatum, Penicillium frequentas, Penicillium fuscum, Penicillium gaestrivorus, Penicillium glabrum, Penicillium griseofulvum, Penicillium implicatum, Penicillium janthinellum, Penicillium lilacinum, Penicillium minioluteum, Penicillium montanense, Penicillium nigricans, Penicillium oxalicum, Penicillium pinetorum, Penicillium pinophilum, Penicillium purpurogenum, Penicillium radicans, Penicillium radicum, Penicillium raistrickii, Penicillium rugulosum, Penicillium simplicissimum, Penicillium solitum, Penicillium variabile, Penicillium velutinum, Penicillium viridicaturn, Penicillium glaucum, Penicillium fussiporus, and Penicillium expansum, Pseudomonas corrugate, Pseudomonas fluorescens, Pseudomonas lutea, Pseudomonas poae, Pseudomonas putida, Pseudomonas stutzeri, Pseudomonas trivialis, Serratia marcescens, Stenotrophomonas maltophilia, Swaminathania salitolerans, Thiobacillus ferrooxidans, Torulospora globosa, Vibrio proteolyticus, Xanthobacter agilis, Xanthomonas campestris, and combinations thereof.

In a particular embodiment, the one or more phosphate solubilizing microorganisms is a strain of the fungus Penicillium. In another embodiment, the one or more Penicillium species is P. bilaiae, P. gaestrivorus, or combinations thereof.

In a particular embodiment, the one or more phosphate solubilizing microorganisms is a strain of the fungus Penicillium. In another embodiment, the one or more Penicillium species is P. bilaiae, P. gaestrivorus, or combinations thereof. In a particular embodiment, the strain of Penicillium comprises P. bilaiae NRRL 50169, P. bilaiae ATCC 20851, P. bilaiae ATCC 22348, P. bilaiae ATCC 18309, P. bilaiae NRRL 50162 and combinations thereof. In another particular embodiment, the strain of Penicillium comprises strain P. gaestrivorus NRRL 50170. In still yet another particular embodiment, the strain of Penicillium comprises P. bilaiae NRRL 50169, P. bilaiae ATCC 20851, P. bilaiae ATCC 22348, P. bilaiae ATCC 18309, P. bilaiae NRRL 50162, P. gaestrivorus NRRL 50170, and combinations thereof.

In another embodiment the beneficial microorganism is one or more mycorrhiza. In particular, the one or more mycorrhiza is an endomycorrhiza (also called vesicular arbuscular mycorrhizas, VAMs, arbuscular mycorrhizas, or AMs), an ectomycorrhiza, or a combination thereof.

In one embodiment, the one or more mycorrhiza is an endomycorrhiza of the phylum Glomeromycota and genera Glomus and Gigaspora. In still a further embodiment, the endomycorrhiza is a strain of Glomus aggregatum, Glomus brasilianum, Glomus clarum, Glomus deserticola, Glomus etunicatum, Glomus fasciculatum, Glomus intraradices, Glomus monosporum, or Glomus mosseae, Gigaspora margarita, or a combination thereof.

In another embodiment, the one or more mycorrhiza is an ectomycorrhiza of the phylum Basidiomycota, Ascomycota, and Zygomycota. In still yet another embodiment, the ectomycorrhiza is a strain of Laccaria bicolor, Laccaria laccata, Pisolithus tinctorius, Rhizopogon amylopogon, Rhizopogon fulvigleba, Rhizopogon luteolus, Rhizopogon villosuli, Scleroderma cepa, Scleroderma citrinum, or a combination thereof.

In still another embodiment, the one or more mycorrhiza is an ecroid mycorrhiza, an arbutoid mycorrhiza, or a monotropoid mycorrhiza. Arbuscular and ectomycorrhizas form ericoid mycorrhiza with many plants belonging to the order Ericales, while some Ericales form arbutoid and monotropoid mycorrhizas. All orchids are mycoheterotrophic at some stage during their lifecycle and form orchid mycorrhizas with a range of basidiomycete fungi. In one embodiment, the mycorrhiza may be an ericoid mycorrhiza, preferably of the phylum Ascomycota, such as Hymenoscyphous ericae or Oidiodendron sp. In another embodiment, the mycorrhiza also may be an arbutoid mycorrhiza, preferably of the phylum Basidiomycota. In yet another embodiment, the mycorrhiza may be a monotripoid mycorrhiza, preferably of the phylum Basidiomycota. In still yet another embodiment, the mycorrhiza may be an orchid mycorrhiza, preferably of the genus Rhizoctonia.

In still another embodiment, the one or more beneficial microorganisms are fungicides, i.e., have fungicidal activity, (e.g., biofungicides). Non-limiting examples of biofungicides are provided below in the “Fungicides” section.

Fungicide(s):

In one embodiment, the compositions described herein may further comprise one or more fungicides. Fungicides useful to the compositions described herein may be biological fungicides, chemical fungicides, or combinations thereof. Fungicides may be selected so as to be provide effective control against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). More common fungal pathogens that may be effectively targeted include Pytophthora, Rhizoctonia, Fusarium, Pythium, Phomopsis or Selerotinia and Phakopsora and combinations thereof.

In certain embodiments, the biological fungicide can be a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comomonas, Corynebacterium, Curtobacterium, Enterobacter, Flavobacterium, Gluconobacter, Hydrogenophage, Klebsiella, Methylobacterium, Paenibacillus, Pasteuria, Phingobacterium, Photorhabdus, Phyllobacterium, Pseudomonas, Rhizobium, Serratia, Stenotrophomonas, Variovorax, and Xenorhadbus. In particular embodiments the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomona fluorescens.

In certain embodiments the biological fungicide can be a fungus of the genus Alternaria, Ampelomyces, Aspergillus, Aureobasidium, Beauveria, Colletotrichum, Coniothyrium, Gliocladium, Metarhizium, Muscodor, Paecilonyces, Trichoderma, Typhula, Ulocladium, and Verticilium. In particular embodiments the fungus is Beauveria bassiana, Coniothyrium minitans, Gliocladium virens, Metarhizium anisopliae, Muscodor albus, Paecilomyces lilacinus, or Trichoderma polysporum.

Non-limiting examples of biological fungicides that may be suitable for use in the present disclosure include Ampelomyces quisqualis (e.g., AQ 10® from Intrachem Bio GmbH & Co. KG, Germany), Aspergillus flavus (e.g., AFLAGUARD® from Syngenta, CH), Aureobasidium pullulans (e.g., BOTECTOR® from bio-ferm GmbH, Germany), Bacillus pumilus (e.g., isolate NRRL-Nr. B-21661 in RHAPSODY®, SERENADE® MAX and SERENADE® ASO from Fa. AgraQuest Inc., USA), Bacillus amyloliquefaciens, Bacillus amyloliquefaciens FZB24 (e.g., TAEGRO® from Novozymes Biologicals, Inc., USA), Bacillus amyloliquefaciens TJ1000 (e.g., also known as 1 BE, isolate ATCC BAA-390), Candida oleophila, Candida oleophila 1-82 (e.g., ASPIRE® from Ecogen Inc., USA), Candida saitoana (e.g., BIOCURE® (in mixture with lysozyme) and BIOCOAT® from Micro Flo Company, USA (BASF SE) and Arysta), Clonostachys rosea f. catenulata, also named Gliocladium catenulatum (e.g., isolate J1446: PRESTOP® from Verdera, Finland), Coniothyrium minitans (e.g., CONTANS® from Prophyta, Germany), Cryphonectria parasitica (e.g., Endothia parasitica from CNICM, France), Cryptococcus albidus (e.g., YIELD PLUS® from Anchor Bio-Technologies, South Africa), Fusarium oxysporum (e.g., BIOFOX® from S.I.A.P.A., Italy, FUSACLEAN® from Natural Plant Protection, France), Metschnikowia fructicola (e.g., SHEMER® from Agrogreen, Israel), Microdochium dimerum (e.g., ANTIBOT® from Agrauxine, France), Phlebiopsis gigantea (e.g., ROTSOP® from Verdera, Finland), Pseudozyma flocculosa (e.g., SPORODEX® from Plant Products Co. Ltd., Canada), Pythium oligandrum, Pythium oligandrum DV74 (e.g., POLYVERSUM® from Remeslo SSRO, Biopreparaty, Czech Rep.), Reynoutria sachlinensis (e.g., REGALIA® from Marrone Biolnnovations, USA), Talaromyces flavus, Talaromyces flavus V117b (e.g., PROTUS® from Prophyta, Germany), Trichoderma asperellum, Trichoderma asperellum SKT-1 (e.g., ECO-HOPE® from Kumiai Chemical Industry Co., Ltd., Japan), Trichoderma atroviride, Trichoderma atroviride LC52 (e.g., SENTINEL® from Agrimm Technologies Ltd, NZ), Trichoderma harzianum, Trichoderma harzianum T-22 (e.g., PLANTSHIELD® der Firma BioWorks Inc., USA), Trichoderma harzianum TH 35 (e.g., ROOT PRO® from Mycontrol Ltd., Israel), Trichoderma harzianum T-39 (e.g., TRICHODEX® and TRICHODERMA 2000® from Mycontrol Ltd., Israel and Makhteshim Ltd., Israel), T. harzianum ICC012, T. harzianum and T. viride (e.g., TRICHOPEL from Agrimm Technologies Ltd, NZ), T. harzianum ICC012 and T. viride ICC080 (e.g., REMEDIER® from Isagro Ricerca, Italy), T. polysporum and T. harzianum (e.g., BINAB® from BINAB Bio-Innovation AB, Sweden), Trichoderma stromaticum (e.g., TRICOVAB® from C.E.P.L.A.C., Brazil), Trichoderma virens, T. virens GL-21 (e.g., SOILGARD® from Certis LLC, USA), T. virens G1-3 (e.g., ATCC 58678, from Novozymes BioAg, Inc.), T. virens G1-21 (e.g., commercially available from Thermo Trilogy Corporation) Trichoderma viride (e.g., TRIECO® from Ecosense Labs. (India) Pvt. Ltd., Indien, BIO-CURE® F from T. Stanes & Co. Ltd., Indien), T. viride TV1 (e.g., T. viride TV1 from Agribiotec srl, Italy), T. viride ICC080, Streptomyces lydicus, Streptomyces lydicus WYEC 108 (e.g., isolate ATCC 55445 in ACTINOVATE®, ACTINOVATE AG®, ACTINOVATE STP®, ACTINO-IRON®, ACTINOVATE L&G®, and ACTINOGROW® from Idaho Research Foundation, USA), Streptomyces violaceusniger, Streptomyces violaceusniger YCED 9 (e.g., isolate ATCC 55660 in DE-THATCH-9®, DECOMP-9®, and THATCH CONTROL® from Idaho Research Foundation, USA), Streptomyces WYE 53 (e.g., isolate ATCC 55750 in DE-THATCH-9®, DECOMP-9®, and THATCH CONTROL® from Idaho Research Foundation, USA) and Ulocladium oudemansii, Ulocladium oudemansii HRU3 (e.g., BOTRY-ZEN® from Botry-Zen Ltd, NZ).

In a particular embodiment, the biofungicide is Bacillus amyloliquefaciens FZB24. In another particular embodiment, the biofungicide is Bacillus amyloliquefaciens TJ1000. In yet another particular embodiment, the biofungicide is Streptomyces lydicus WYEC 108. In still yet another particular embodiment, the biofungicide is Streptomyces violaceusniger YCED 9. In another particular embodiment, the biofungicide is Streptomyces WYE 53. In yet another particular embodiment, the biofungicide is Trichoderma virens G1-3. In another particular embodiment, the biofungicide is Trichoderma virens G1-21.

In still another particular embodiment, the biofungicide is a combination of Bacillus amyloliquefaciens FZB24, Bacillus amyloliquefaciens TJ1000, Streptomyces lydicus WYEC 108, Streptomyces violaceusniger YCED 9, Streptomyces WYE 53, Trichoderma virens G1-3, Trichoderma virens G1-21, or combinations thereof (e.g., at least one, at least two, at least three, at least four, at least five, at least six, at least seven, up to and including all of the strains in combination).

In further embodiments the biological fungicide can be plant growth activators or plant defense agents including, but not limited to harpin, Reynoutria sachalinensis, etc.

Representative examples of useful chemical fungicides that may be suitable for use in the present disclosure include aromatic hydrocarbons, benzimidazoles, benzthiadiazole, carboxamides, carboxylic acid amides, morpholines, phenylamides, phosphonates, quinone outside inhibitors (e.g. strobilurins), thiazolidines, thiophanates, thiophene carboxamides, and triazoles:

A) Strobilurins:

azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide;

B) Carboxamides:

carboxanilides: benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyra-zole-4-carboxamide and N-(2-(1,3,3-trimethylbutyl)-phenyl)-1,3-dimethyl-5-fluoro-1H-pyrazole-4-carboxamide;

carboxylic morpholides: dimethomorph, flumorph, pyrimorph; benzoic acid amides: flumetover, fluopicolide, fluopyram, zoxamide;

other carboxamides: carpropamid, dicyclomet, mandiproamid, oxytetracyclin, silthiofam and N-(6-methoxy-pyridin-3-yl)cyclopropanecarboxylic acid amide;

C) Azoles:

triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;

imidazoles: cyazofamid, imazalil, pefurazoate, prochloraz, triflumizol;

D) Heterocyclic Compounds:

pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine;

pyrimidines: bupirimate, cyprodinil, diflumetorim, fenarimol, ferimzone, mepanipyrim, nitrapyrin, nuarimol, pyrimethanil;

piperazines: triforine;

pyrroles: fenpiclonil, fludioxonil;

morpholines: aldimorph, dodemorph, dodemorph-acetate, fenpropimorph, tridemorph;

piperidines: fenpropidin;

dicarboximides: fluoroimid, iprodione, procymidone, vinclozolin;

non-aromatic 5-membered heterocycles: famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester;

others: acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine;

E) Benzamidazoles:

carbendazim.

F) Other Active Substances:

guanidines: guanidine, dodine, dodine free base, guazatine, guazatine-acetate, iminoctadine, iminoctadine-triacetate, iminoctadine-tris(albesilate);

antibiotics: kasugamycin, kasugamycin hydrochloride-hydrate, streptomycin, polyoxine, validamycin A;

nitrophenyl derivates: binapacryl, dicloran, dinobuton, dinocap, nitrothal-isopropyl, tecnazen,

organometal compounds: fentin salts, such as fentin-acetate, fentin chloride or fentin hydroxide;

sulfur-containing heterocyclyl compounds: dithianon, isoprothiolane;

organophosphorus compounds: edifenphos, fosetyl, fosetyl-aluminum, iprobenfos, phosphorus acid and its salts, pyrazophos, tolclofos-methyl;

organochlorine compounds: chlorothalonil, dichlofluanid, dichlorophen, flusulfamide, hexachlorobenzene, pencycuron, pentachlorphenole and its salts, phthalide, quintozene, thiophanate-methyl, thiophanate, tolylfluanid, N-(4-chloro-2-nitro-phenyl)-N-ethyl-4-methyl-benzenesulfonamide;

inorganic active substances: Bordeaux mixture, copper acetate, copper hydroxide, copper oxychloride, basic copper sulfate and sulfur.

Commercial fungicides are most suitably used in accordance with the manufacturer's instructions at the recommended concentrations.

Herbicide(s):

In one embodiment, the compositions described herein may further comprise one or more herbicides. Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins. In a particular embodiment, the herbicide may be a pre-emergent herbicide, a post-emergent herbicide, or a combination thereof.

Suitable herbicides include chemical herbicides, natural herbicides (e.g., bioherbicides, organic herbicides, etc.), or combinations thereof. Non-limiting examples of suitable herbicides include acetochlor, dicamba, bentazon, acifluorfen, chlorimuron, lactofen, clomazone, fluazifop, flumioxazin, glufosinate, glyphosate, sethoxydim, imazethapyr, imazamox, fomesafe, fomesafen, flumiclorac, imazaquin, mesotrione, quizalofop, saflufenacil, sulcotrione, 2,4-dichlorophenoxyacetic acid (2,4-D), 2,4,5-trichlorophenoxyacetic acid (2,4,5-T), thaxtomin (e.g., the thaxtomins as described in U.S. Pat. No. 7,989,393), and clethodim. Commercial products containing each of these compounds are readily available. Herbicide concentration in the composition will generally correspond to the labeled use rate for a particular herbicide.

Insecticide(s), Acaricide(s) Nematicide(s):

In one embodiment, the compositions described herein may further comprise one or more insecticides, acaricides, nematicides, or combinations thereof. Insecticides useful to the compositions described herein will suitably exhibit activity against a broad range of insects including, but not limited to, wireworms, cutworms, grubs, corn rootworm, seed corn maggots, flea beetles, chinch bugs, aphids, leaf beetles, stink bugs, and combinations thereof. The insecticides, acaricides, and nematicides described herein may be chemical or natural (e.g., biological solutions, such as fungal pesticides, etc.).

Non-limiting examples of insecticides, acaricides, and nematicides that may be useful to the compositions disclosed herein include carbamates, diamides, macrocyclic lactones, neonicotinoids, organophosphates, phenylpyrazoles, pyrethrins, spinosyns, synthetic pyrethroids, tetronic and tetramic acids.

In particular embodiments insecticides, acaricides, and nematicides include acrinathrin, alpha-cypermethrin, betacyfluthrin, cyhalothrin, cypermethrin, deltamethrin csfenvalcrate, etofenprox, fenpropathrin, fenvalerate, flucythrinat, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (Rynaxypyr), chlothianidin, Cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, aldoxycarb, metamidophos, methiocarb, sulfoxaflor, cyantraniliprole, and also products based on Bacillus firmus (1-1582, BioNeem, Votivo), and combinations thereof.

In a particular embodiment, the inseciticde is a microbial insecticide. In a more particular embodiment, the microbial insecticide is a fungal insecticide. Non-limiting examples of fungal insecticides that may be used in the compositions disclosed herein are described in McCoy, C. W., Samson, R. A., and Coucias, D. G. “Entomogenous fungi. In “CRC Handbook of Natural Pesticides. Microbial Pesticides, Part A. Entomogenous Protozoa and Fungi.” (C. M. Inoffo, ed.), (1988): Vol. 5, 151-236; Samson, R. A., Evans, H.C., and Latge', J. P. “Atlas of Entomopathogenic Fungi.” (Springer-Verlag, Berlin) (1988); and deFaria, M. R. and Wraight, S. P. “Mycoinsecticides and Mycoacaricides: A comprehensive list with worldwide coverage and international classification of formulation types.” Biol. Control (2007), doi: 10.1016/j.biocontrol.2007.08.001.

In one embodiment, non-limiting examples fungal insecticides that may be used in the compositions disclosed herein include species of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, Uredinella, and combinations thereof.

Non-limiting examples of particular species that may be useful as a fungal insecticide in the compositions described herein include Trichoderma hamatum, Trichoderma hazarium, Alternaria cassiae, Fusarium lateritum, Fusarium solani, Lecanicillium lecanii, Aspergillus parasiticus, Verticillium lecanii, Metarhizium anisopliae, and Beauveria bassiana. In an embodiment, the compositions disclosed herein may include any of the fungal insecticides provided above, including any combination thereof.

In one embodiment, the composition comprises at least one fungal insecticide from the genus Metarhizium spp., such as, Metarhizium anisopliae (also may be referred to in the art as Metarrhizium anisopliae, Metarhizium brunneum, or “green muscadine”). In at least one embodiment, the fungal insecticide comprises the strain Metarhizium anisopliae. In another embodiment, the composition comprises spores of the strain Metarhizium anisopliae.

In a particular embodiment, the composition comprises at least one fungal pesticide comprising Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001 and deposited as DSM 3884, DSM 3885, ATCC 90448, SD 170, and ARSEF 7711) (available from Novozymes Biologicals, Inc., USA). In still another particular embodiment, the composition comprises at least one fungal insecticide comprising spores of Metarhizium anisopliae strain F52.

In yet another embodiment the composition may further comprise at least one fungal insecticide from the genus Beauveria spp., such as, for example, Beauveria bassiana. In at least one embodiment, the fungal insecticide further comprises the strain Beauveria bassiana. In another embodiment, the composition further comprises spores of the strain Beauveria bassiana.

In a particular embodiment, the composition further comprises at least one fungal insecticide comprising Beauveria bassiana strain ATCC-74040. In another embodiment, the composition further comprises at least one fungal insecticide comprising spores of Beauveria bassiana strain ATCC-74040. In another particular embodiment, the composition further comprises at least one fungal insecticide comprising Beauveria bassiana strain ATCC-74250. In still another particular embodiment, the composition further comprises at least one fungal insecticide comprising spores of Beauveria bassiana strain ATCC-74250. In yet another particular embodiment, the composition further comprises at least one fungal insecticide comprising a mixture of Beauveria bassiana strain ATCC-74040 and Beauveria bassiana strain ATCC-74250. In still another embodiment, the composition further comprises at least one fungal insecticide comprising a mixture of spores of Beauveria bassiana strain ATCC-74040 and Beauveria bassiana strain ATCC-74250.

In still yet another particular embodiment, the composition described herein may comprise a combination of fungi. In one embodiment, the composition may comprise two or more fungal insecticides that are different strains of the same species. In another embodiment, the composition comprises at least two different fungal insecticides that are strains of different species. In an embodiment, the composition comprises at least one fungal insecticide from the genus Metarhizium spp. and at least one fungal insecticide from the genus Beauveria spp. In another embodiment, the composition comprises spores of Metarhizium spp. and Beauveria spp.

In a particular embodiment, the composition comprises at least one fungal insecticide, wherein at least one fungal insecticide is a strain of Metarhizium anisopliae and at least one fungal insecticide is a strain of Beauveria bassiana. In another embodiment, the composition comprises at least one fungal insecticide wherein the fungal insecticide comprises spores of Metarhizium anisopliae and Beauveria bassiana.

In a more particular embodiment, the composition comprises at least one fungal insecticide, wherein at least one fungal insecticide is a strain of Metarhizium anisopliae F52 and at least one fungal insecticide is a strain of the strain Beauveria bassiana ATCC-74040. In yet another embodiment, the composition comprises at least one fungal insecticide wherein the fungal insecticide comprises spores of the strain Metarhizium anisopliae F52 and the strain Beauveria bassiana ATCC-74040.

In still another particular embodiment, the composition comprises at least one fungal insecticide, wherein at least one fungal insecticide is a strain of Metarhizium anisopliae F52 and at least one fungal insecticide is a strain of the strain Beauveria bassiana ATCC-74250. In yet another embodiment, the composition comprises at least one fungal insecticide wherein the fungal insecticide comprises spores of the strain Metarhizium anisopliae F52 and the strain Beauveria bassiana ATCC-74250.

In still yet another particular embodiment, the composition comprises at least one fungal insecticide, wherein at least one fungal insecticide is a strain of Metarhizium anisopliae F52, at least one fungal insecticide is a strain of the strain Beauveria bassiana ATCC-74040, and at least one fungal insecticide is a strain of the strain Beauveria bassiana ATCC-74250. In yet another embodiment, the composition comprises at least one fungal insecticide wherein the fungal insecticide comprises spores of the strain Metarhizium anisopliae F52, the strain Beauveria bassiana ATCC-74040, and the strain Beauveria bassiana ATCC-74250.

In another embodiment, the composition comprises at least one fungal insecticide, wherein at least one fungal insecticide is a strain of Paecilomyces fumosoroseus. In yet another embodiment, the composition comprises at least one fungal insecticide, wherein at least one fungal insecticide is a strain of Paecilomyces fumosoroseus FE991 (in NOFLY® from FuturEco BioScience S.L., Barcelona, Spain). In still yet another embodiment, the composition comprises at least one fungal insecticide, wherein at least one fungal insecticide wherein the at least one fungal insecticide is a strain of Paecilomyces fumosoroseus FE991 at least one fungal insecticide is a strain of Metarhizium anisopliae F52, at least one fungal insecticide is a strain of the strain Beauveria bassiana ATCC-74040, and at least one fungal insecticide is a strain of the strain Beauveria bassiana ATCC-74250, and combinations thereof.

In another embodiment, the compositions disclosed herein comprise a nematicide. In a more particular embodiment, the nematicide is a microbial nematicide, more preferably a nematophagous fungus and/or nematophagous bacteria. In a particular embodiment, the microbial nematicide is a nematophagous fungus selected from the group consisting of Arthrobotrys spp., Dactylaria spp., Harposporium spp., Hirsutella spp., Monacrosporium spp., Nematoctonus spp., Meristacrum spp., Myrothecium spp., Paecilomyces spp., Pasteuria spp., Pochonia spp., Trichoderma spp., Verticillium spp., and combinations thereof. In still a more particular embodiment, the nematophagous fungus is selected from the group consisting of Arthrobotrys dactyloides, Arthrobotrys oligospora, Arthrobotrys superb, Arthrobotrys dactyloides, Dactylaria candida, Harposporium anguillulae, Hirsutella rhossiliensis, HirsuteIla minnesotensis, Monacrosporium cionopagum, Nematoctonus geogenius, Nematoctonus leiosporus, Meristacrum asterospermum, Myrothecium verrucaria, Paecilomyces lilacinus, Paecilomyces fumosoroseus, Pasteuria penetrans, Pasteuria usgae, Pochonia chlamydopora, Trichoderma harzianum, Trichoderma virens, Verticillium chlamydosporum, and combinations thereof.

In a more particular embodiment, the microbial nematicide is a nematophagous bacteria selected from the group consisting of Actinomycetes spp., Agrobacterium spp., Arthrobacter spp., Alcaligenes spp., Aureobacterium spp., Azobacter spp., Beijerinckia spp., Burkholderia spp., Chromobacterium spp., Clavibacter spp., Clostridium spp., Comomonas spp., Corynebacterium spp., Curtobacterium spp., Desulforibtio spp., Enterobacter spp., Flavobacterium spp., Gluconobacter spp., Hydrogenophage spp., Klebsiella spp., Methylobacterium spp., Phyllobacterium spp., Phingobacterium spp., Photorhabdus spp., Serratia spp. Stenotrotrophomonas spp., Xenorhadbus spp. Variovorax spp., Streptomyces spp., Pseudomonas spp., Paenibacillus spp., and combinations thereof.

In still a more particular embodiment, the microbial nematicide is a nematophagous bacteria selected from the group consisting of Chromobacterium subtsugae, Chromobacterium violaceum, Streptomyces lydicus, Streptomyces violaceusniger, and combinations thereof. In a particular embodiment, the strain of Chromobacterium subtsugae is a strain of Chromobacterium subtsugae sp. nov., more particularly, the strain of Chromobacterium subtsugae sp. nov. has the deposit accession number NRRL B-30655. In still another particular embodiment, the strain of Streptomyces is a strain of Streptomyces lydicus WYEC 108, a strain of Streptomyces violaceusniger YCED 9, Streptomyces WYE53 or a combination thereof.

Nutrient(s):

In still another embodiment, the compositions described herein may further comprise one or more beneficial nutrients. Non-limiting examples of nutrients for use in the compositions described herein include vitamins, (e.g., vitamin A, vitamin B complex (i.e., vitamin B₁, vitamin B₂, vitamin B₃, vitamin B₅, vitamin B₆, vitamin B₇, vitamin B₈, vitamin B₉, vitamin B₁₂, choline) vitamin C, vitamin D, vitamin E, vitamin K, carotenoids (α-carotene, β-carotene, cryptoxanthin, lutein, lycopene, zeaxanthin, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), organic acids (e.g., acetic acid, citric acid, lactic acid, malic aclid, taurine, etc.), and combinations thereof. In a particular embodiment, the compositions may comprise phosphorous, boron, chlorine, copper, iron, manganese, molybdenum, zinc or combinations thereof.

In another embodiment, the compositions described herein may further comprise phosphorus. In one embodiment, the phosphorus may be derived from a source. In another embodiment, suitable sources of phosphorus include phosphorus sources capable of solubilization by one or more microorganisms (e.g., Penicillium bilaiae, etc.).

In one embodiment, the phosphorus may be derived from a rock phosphate source. In another embodiment the phosphorus may be derived from fertilizers comprising one or more phosphorus sources. Commercially available manufactured phosphate fertilizers are of many types. Some common ones are those containing rock phosphate, monoammonium phosphate, diammonium phosphate, monocalcium phosphate, super phosphate, triple super phosphate, and/or ammonium polyphosphate. All of these fertilizers are produced by chemical processing of insoluble natural rock phosphates in large scale fertilizer-manufacturing facilities and the product is expensive. By means of the present disclosure it is possible to reduce the amount of these fertilizers applied to the soil while still maintaining the same amount of phosphorus uptake from the soil.

In still another embodiment, the phosphorus may be derived from an organic phosphorus source. In a further particular embodiment, the source of phosphorus may include an organic fertilizer. An organic fertilizer refers to a soil amendment derived from natural sources that guarantees, at least, the minimum percentages of nitrogen, phosphate, and potash. Non-limiting examples of organic fertilizers include plant and animal by-products, rock powders, seaweed, inoculants, and conditioners. These are often available at garden centers and through horticultural supply companies. In particular the organic source of phosphorus is from bone meal, meat meal, animal manure, compost, sewage sludge, or guano, or combinations thereof.

In still another embodiment, the phosphorus may be derived from a combination of phosphorus sources including, but not limited to, rock phosphate, fertilizers comprising one or more phosphorus sources (e.g., monoammonium phosphate, diammonium phosphate, monocalcium phosphate, super phosphate, triple super phosphate, ammonium polyphosphate, etc.) one or more organic phosphorus sources, and combinations thereof.

Biostimulant(s):

In one embodiment, the compositions described herein may comprise one or more beneficial biostimulants. Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myo-inositol, glycine, and combinations thereof. In another embodiment, the compositions comprise seaweed extracts, humic acids, fulvic acids, myo-inositol, glycine, and combinations thereof.

Polymer(s):

In one embodiment, the compositions described herein may further comprise one or more polymers. Non-limiting uses of polymers in the agricultural industry include agrochemical delivery, heavy metal removal, water retention and/or water delivery, and combinations thereof. Pouci, et al., Am. J. Agri. & Biol. Sci., 3(1):299-314 (2008). In one embodiment, the one or more polymers is a natural polymer (e.g., agar, starch, alginate, pectin, cellulose, etc.), a synthetic polymer, a biodegradable polymer (e.g., polycaprolactone, polylactide, poly (vinyl alcohol), etc.), or a combination thereof.

For a non-limiting list of polymers useful for the compositions described herein, see Pouci, et al., Am. J. Agri. & Biol. Sci., 3(1):299-314 (2008). In one embodiment, the compositions described herein comprise cellulose, cellulose derivatives, methylcellulose, methylcellulose derivatives, starch, agar, alginate, pectin, polyvinylpyrrolidone, and combinations thereof.

Wetting Agent(s):

In one embodiment, the compositions described herein may further comprise one or more wetting agents. Wetting agents are commonly used on soils, particularly hydrophobic soils, to improve the infiltration and/or penetration of water into a soil. The wetting agent may be an adjuvant, oil, surfactant, buffer, acidifier, or combination thereof. In an embodiment, the wetting agent is a surfactant. In an embodiment, the wetting agent is one or more nonionic surfactants, one or more anionic surfactants, or a combination thereof. In yet another embodiment, the wetting agent is one or more nonionic surfactants.

Surfactants suitable for the compositions described herein are provided in the “Surfactants” section.

Surfactant(s):

Surfactants suitable for the compositions described herein may be non-ionic surfactants (e.g., semi-polar and/or anionic and/or cationic and/or zwitterionic). The surfactants can wet and emulsify soil(s) and/or dirt(s). It is envisioned that the surfactants used in described composition have low toxicity for any microorganisms contained within the formulation. It is further envisioned that the surfactants used in the described composition have a low phytotoxicity (i.e., the degree of toxicity a substance or combination of substances has on a plant). A single surfactant or a blend of several surfactants can be used.

Anionic Surfactants

Anionic surfactants or mixtures of anionic and nonionic surfactants may also be used in the compositions. Anionic surfactants are surfactants having a hydrophilic moiety in an anionic or negatively charged state in aqueous solution. The compositions described herein may comprise one or more anionic surfactants. The anionic surfactant(s) may be either water soluble anionic surfactants, water insoluble anionic surfactants, or a combination of water soluble anionic surfactants and water insoluble anionic surfactants. Non-limiting examples of anionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, alkyl carboxylates, or a combination thereof.

Nonionic Surfactants

Nonionic surfactants are surfactants having no electrical charge when dissolved or dispersed in an aqueous medium. In at least one embodiment of the composition described herein, one or more nonionic surfactants are used as they provide the desired wetting and emulsification actions and do not significantly inhibit spore stability and activity. The nonionic surfactant(s) may be either water soluble nonionic surfactants, water insoluble nonionic surfactants, or a combination of water soluble nonionic surfactants and water insoluble nonionic surfactants.

Water Insoluble Nonionic Surfactants

Non-limiting examples of water insoluble nonionic surfactants include alkyl and aryl: glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones.

Water Soluble Nonionic Surfactants

Non-limiting examples of water soluble nonionic surfactants include sorbitan fatty acid alcohol ethoxylates and sorbitan fatty acid ester ethoxylates.

Combination of Nonionic Surfactants

In one embodiment, the compositions described herein comprise at least one or more nonionic surfactants. In one embodiment, the compositions comprise at least one water insoluble nonionic surfactant and at least one water soluble nonionic surfactant. In still another embodiment, the compositions comprise a combination of nonionic surfactants having hydrocarbon chains of substantially the same length.

Other Surfactants

In another embodiment, the compositions described herein may also comprise organosilicone surfactants, silicone-based antifoams used as surfactants in silicone-based and mineral-oil based antifoams. In yet another embodiment, the compositions described herein may also comprise alkali metal salts of fatty acids (e.g., water soluble alkali metal salts of fatty acids and/or water insoluble alkali metal salts of fatty acids).

Anti-Freezing Agent(s):

In one embodiment, the compositions described herein may further comprise one or more anti-freezing agents. Non-limiting examples of anti-freezing agents include ethylene glycol, propylene glycol, urea, glycerin, and combinations thereof.

### Methods

In another aspect, methods of using flavonoids to increase and/or enhance plant growth are disclosed. In a particular embodiment, the method includes enhancing the growth of a plant or plant part comprising applying to a plant or plant part one or more of the flavonoids described herein. In a particular embodiment, the applying step includes applying to a plant or plant part one or more of the compositions described herein.

The applying step can be performed by any method known in the art (including both foliar and non-foliar applications). Non-limiting examples of applying to the plant or plant part include spraying a plant or plant part, drenching a plant or plant part, dripping on a plant or plant part, dusting a plant or plant part, and/or coating a seed. In a more particular embodiment, the applying step is repeated (e.g., more than once, as in the contacting step is repeated twice, three times, four times, five times, six times, seven times, eight times, nine times, ten times, etc.).

In a particular embodiment the applying step comprises foliarly applying to a plant or plant part (i.e., application to the plant by spraying, e.g., via foliar spray, a predosage device, a knapsack sprayer, a spray tank or a spray plane) one or more of the flavonoids or compositions described herein. In still yet a more particular embodiment, the applying step comprises applying one or more flavonoids or compositions described herein to plant foliage.

In another embodiment, the method further comprises applying to the plant or plant part one or more agriculturally beneficial ingredients described herein. Application of the one or more agriculturally beneficial ingredients can be applied to the plant or plant parts as part of a composition described herein or applied independently from the one or more flavonoids described herein. In one embodiment, the one or more agriculturally beneficial ingredients are applied to the plant or plant parts as part of a composition described herein. In another embodiment, the one or more agriculturally beneficial ingredients are applied to the plant or plant parts independently from the one or more flavonoids described herein. In one embodiment, the step of applying the one or more agriculturally beneficial ingredients to the plant or plant part occurs before, during, after, or simultaneously with the step of contacting a plant or plant part with one or more of flavonoids described herein.

In another aspect, a method for enhancing the growth of a plant or plant part is described comprising treating a soil with one or more of the flavonoids described herein, and growing a plant or plant part in the treated soil.

In an embodiment, the treating step can be performed by any method known in the art. Non-limiting examples of treating the soil include spraying the soil, drenching the soil, dripping onto the soil, and/or dusting the soil. In one embodiment, the treating step is repeated (e.g., more than once, as in the treating step is repeated twice, three times, four times, five times, six times, seven times, eight times, nine times, ten times, etc.). In a particular embodiment, the treating step comprised introducing one or more of the compositions described herein to the soil.

The treating step can occur at any time during the growth of the plant or plant part. In one embodiment, the treating step occurs before the plant or plant part begins to grow. In another embodiment, the treating step occurs after the plant or plant part has started to grow.

In another embodiment, the method further comprises the step of planting a plant or plant part. The planting step can occur before, after or during the treating step. In one embodiment, the planting step occurs before the treating step. In another embodiment, the planting step occurs during the treating step (e.g., the planting step occurs simultaneously with the treating step, the planting step occurs substantially simultaneous with the treating step, etc.). In still another embodiment, the planting step occurs after the treating step.

In another embodiment, the method further comprises the step of subjecting the soil to one or more agriculturally beneficial ingredients described herein. The soil can be subjected to the one or more agriculturally beneficial ingredients as part of a composition described herein or independently from the one or more flavonoids described herein. In one embodiment, the soil is subjected to the one or more agriculturally beneficial ingredients as part of a composition described herein. In another embodiment, the soil is subjected to one or more agriculturally beneficial ingredients independently from the one or more flavonoids described herein.

In one embodiment, the step of subjecting the soil to one or more agriculturally beneficial ingredients occurs before, during, after, or simultaneously with the treating step. In one embodiment, the step of subjecting the soil to one or more agriculturally beneficial ingredients as described herein occurs before the treating step. In another embodiment, the step of subjecting the soil to one or more agriculturally beneficial ingredients as described herein occurs during the treating step. In still another embodiment, the step of subjecting the soil to one or more agriculturally beneficial ingredients as described herein occurs after the treating step. In yet another embodiment, the step of subjecting the soil to one or more agriculturally beneficial ingredients as described herein occurs simultaneously with the treating step (e.g., treating the soil with one or more of the compositions described herein, etc.).

The methods of the present disclosure are applicable to both and non-leguminous plants or plant parts. In a particular embodiment the plants or plant parts are selected from the group consisting of alfalfa, rice, wheat, barley, rye, oat, cotton, canola, sunflower, peanut, corn, potato, sweet potato, bean, pea, chickpeas, lentil, chicory, lettuce, endive, cabbage, brussel sprout, beet, parsnip, turnip, cauliflower, broccoli, turnip, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, sorghum, and sugarcane.

The embodiments of the disclosure are further defined by the following numbered paragraphs:

1. A method for enhancing the growth of a plant or plant part comprising foliarly applying to a plant or plant part one or more flavonoids.

2. The method of paragraph 1, wherein the one or more flavonoids is selected from the group consisting of catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), flavan-4-ol, leucoanthocyanidin, proanthocyanidins, luteolin, apigenin, tangeritin, quercetin, quercitrin, rutin, kaempferol, kaempferitrin, astragalin, sophoraflavonoloside, myricetin, fisetin, isorhamnetin, pachypodol, rhamnazin, hesperetin, hesperidin, naringenin, eriodictyol, homoeriodictyol, dihydroquercetin, dihydrokaempferol, cyanidins, delphinidins, malvidins, pelargonidins, peonidins, petunidins, genistein, daidzein, glycitein, equol, lonchocarpane, laxiflorane, calophyllolide, dalbergichromene, coutareagenin, dalbergin, nivetin, and combinations thereof.

3. The method of paragraphs 1 or 2, wherein the one or more flavonoids is genistein.

4. The method of paragraphs 1 or 2, wherein the one or more flavonoids is daidzein.

5. The method of paragraphs 1 or 2, wherein the one or more flavonoids is hesperetin.

6. The method of paragraphs 1 or 2, wherein the one or more flavonoids is naringenin.

7. The method of paragraphs 1 or 2, wherein the one or more flavonoids is a mixture of genistein and daidzein.

8. The method of paragraph 7, wherein the ratio between genistein and daidzein is in the range from 10:1 to 1:10, preferably 8:2 to 1:1.

9. The method of paragraphs 1 or 2, wherein the one or more flavonoids is a mixture of hesperetin and naringenin.

10. The method of paragraph 9, wherein the ratio between hesperetin and naringenin is in the range from 10:1 to 1:10, preferably 7:3 to 1:1.

11. The method of paragraphs 1 or 2, wherein the one or more flavonoids is a mixture of genistein, daidzein hesperetin, and naringenin.

12. The method of paragraph 11, wherein the ratio between genistein, daidzein hesperetin, and naringenin is in the range from 10:1:1:1 to 1:10:10:10, preferably 1:1:1:1:1.

13. The method of paragraph 11, wherein the ratio between genistein, daidzein hesperetin, and naringenin is a 50:50 blend of genistein and daidzein and hesperitin and naringenin wherein the ratio genistein and daidzein is 8:2 and the ratio between hesperitin and naringenin is 7:3.

14. The method of paragraph 1, wherein the method further comprises applying to the plant or plant part one or more agriculturally beneficial ingredients.

15. The method of paragraph 14, wherein the step of applying to the plant or plant part one or more agriculturally beneficial ingredients occurs before, during, after, or simultaneously with the step of foliarly applying to plant or plant part with one or more flavonoids.

16. The method of paragraph 14, wherein the agriculturally beneficial ingredient is a one or more biologically active ingredients.

17. The method of paragraph 16, wherein the one or more biologically active ingredients are selected from the group consisting of one or more plant signal molecules, one or more beneficial microorganisms, and combinations thereof.

18. The method of paragraph 17, wherein the one or more biologically active ingredients are one or more plant signal molecules selected from the group consisting of LCOs, COs, chitinous compounds, jasmonic acid, methyl jasmonate, linoleic acid, linolenic acid, karrikins, and combinations thereof.

19. The method of paragraph 18, wherein the one or more biologically active ingredients comprises one or more COs.

20. The method of paragraph 18, wherein the one or more biologically active ingredients comprises one or more LCOs.

21. The method of paragraph 17, wherein the one or more biologically active ingredients comprises one or more beneficial microorganisms.

22. The method of paragraph 21, wherein the one or more beneficial microorganisms comprise one or more nitrogen fixing microorganisms, one or more phosphate solubilizing microorganisms, one or more mycorrhizal fungi, or combinations thereof.

23. The method of paragraph 16, wherein the one or more agriculturally beneficial ingredients further comprises one or more micronutrients.

24. The method of paragraph 23, wherein the one or more micronutrients comprise phosphorus, copper, iron, zinc, or a combination thereof.

25. The method of paragraph 16, wherein the one or more agriculturally beneficial ingredients further comprises one or more fungicides.

26. The method of paragraph 16, wherein the one or more agriculturally beneficial ingredients further comprises one or more fertilizers.

27. The method of paragraph 16, wherein the one or more agriculturally beneficial ingredients further comprises one or more insecticides, acaricides, nematicides, or combinations thereof.

28. The method of paragraph 1, wherein, the applying step comprises foliarly applying to a plant or plant part a composition comprising the one or more flavonoids.

29. The method of paragraph 28, wherein the composition comprises the composition of any of claims 2-26.

30. The method of any of the preceding paragraphs, wherein the plant or plant part is a leguminous plant or plant part.

31. The method of any of the preceding paragraphs, wherein the plant or plant part is a soybean plant or plant part.

32. The method of any of the preceding paragraphs, wherein the plant or plant part is a non-leguminous plant or plant part

33. The method of any of the preceding paragraphs, wherein the plant or plant part is a corn plant or plant part.

The embodiments will now be described in terms of the following non-limiting examples. Unless indicated to the contrary, water was used as the control (indicated as “control” or “CHK”).

### EXAMPLES

The following examples are provided for illustrative purposes and are not intended to limit the scope of the embodiments as claimed herein. Any variations in the exemplified examples which occur to the skilled artisan are intended to fall within the scope of the present disclosure.

### Field Trials

### Example 1

### Wheat

Five (5) field trials were conducted to evaluate embodiments on grain yield when applied to wheat foliage. The field trials were conducted in North Dakota with various soil characteristics and environmental conditions.

The treatments used in the trials were Control (water with or without a fungicide) and a blend of flavonoids (10 mM concentration of Genistein and Daidzein, in an 8:2 ratio) in formulation (Stepan C-40, m-Pyrol, Toximul 8320 and Toximul 3483) at an application rate for 4.0 fl. oz. per acre. Different commercially available wheat varieties were employed. Treatments were sprayed on the foliage at the time of normal fungicide application. Four ounces per acre of the treatment was combined either with or without a fungicide, plus water and applied at a rate of 5 to 10 gallons per acre. Wheat was grown to maturity, harvested and grain yield determined.

TABLE 1

| | YIELD (bu/A) | |
|---|---|---|
| | Control | Treatment |
| Mean (N = 5) | 33.9 | 34.5 |
| Response (bu/A) | | 0.6 |
| Response Increase (% of | | 1.8% |
| Control) | | |
| Positive Yield Response (%) | | 60.0% |

As reflected in Table 1, by comparison between control and flavonoid, the yield was enhanced by foliar flavonoid treatment by 0.6 bu acre, resulting in a 1.8% yield increase over control, and a positive yield enhancement occurred in 60.0% of the trials. Therefore, flavonoids provided yield enhancements in wheat as a foliar treatment.

### Example 2

### Cotton

Five (5) field trials were conducted to evaluate embodiments of the present disclosure on grain yield when applied to cotton foliage. The field trials were conducted in Arkansas, South Carolina, and Texas with various soil characteristics and environmental conditions.

The treatments used in the trials were Control (water/glyphosate solution) and a blend of flavonoids (10 mM concentration of Genistein and Daidzein, in an 8:2 ratio) in formulation (m-pyrol, DMSO, propylene glycol, and Tween 20) at an application rate for 4.0 fl. oz. per acre. Different commercially available cotton varieties were employed. Treatments were sprayed on the foliage at the time of normal herbicide application. Four ounces per acre of the treatment was combined with glyphosate herbicide, plus water and applied at a rate of 5 to 10 gallons per acre. Cotton was grown to maturity, harvested and lint yield determined or extrapolated.

TABLE 2

| | YIELD (lb. lint/A) | |
|---|---|---|
| | Control | Treatment |
| Mean (N = 5) | 1109.9 | 1141.9 |
| Response (bu/A) | | 32.0 |
| Response Increase (% of | | 2.9% |
| Control) | | |
| Positive Yield Response (%) | | 80.0% |

As reflected in Table 2, by comparison between control and flavonoid, the yield was enhanced by foliar flavonoid treatment by 32.0 lb. lint/acre, resulting in a 2.9% yield increase over control, and a positive yield enhancement occurred in 80.0% of the trials. Therefore, flavonoids provided yield enhancements as a foliar treatment.

### Example 3

### Cotton

Four (4) field trials were conducted to evaluate embodiments of the present disclosure on grain yield when applied to cotton foliage. The field trials were conducted in Arkansas, South Carolina, and Texas with various soil characteristics and environmental conditions.

The treatments used in the trials were Control (water/glyphosate solution) and a blend of flavonoids (10 mM concentration of Genistein and Daidzein, in an 8:2 ratio) in formulation (Stepan C-40, m-Pyrol, Toximul 8320 and Toximul 3483) at an application rate for 4.0 fl. oz. per acre. Different commercially available cotton varieties were employed. Treatments were sprayed on the foliage at the time of normal herbicide application. Four ounces per acre of the treatment was combined with glyphosate herbicide, plus water and applied at a rate of 5 to 10 gallons per acre. Cotton was grown to maturity, harvested and lint yield determined or extrapolated.

TABLE 3

| | YIELD (lb. lint/A) | |
|---|---|---|
| | Control | Treatment |
| Mean (N = 4) | 908.6 | 918.9 |
| Response (bu/A) | | 10.4 |
| Response Increase | | 1.1% |
| (% of Control) | | |
| Positive Yield Response (%) | | 50% |

As reflected in Table 3, by comparison between control and flavonoid, the yield was enhanced by foliar flavonoid treatment by 10.4 lb. lint/acre, resulting in a 1.1% yield increase over control, and a positive yield enhancement occurred in 50.0% of the trials. Therefore, flavonoids provided yield enhancements as a foliar treatment.

### Example 4

### Field Corn (Maize)

Thirty-two (32) field trials were conducted to evaluate embodiments of the present disclosure on grain yield when applied to corn foliage across the USA and Argentina. The field trials were conducted with various soil characteristics and environmental conditions.

The treatments used in the trials were Control (water/glyphosate solution) and a blend of flavonoids (10 mM concentration of Genistein and Daidzein, in an 8:2 ratio) in formulation (Step-flow 26F, Morwet D 454 40%, SAG 30, Propylene glycol, and water) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 4

| | YIELD (bu/A) | |
|---|---|---|
| | Control | Treatment |
| Mean (N = 32) | 177.3 | 183.3 |
| Response (bu/A) | | 5.9 |
| Response Increase | | 3.3% |
| (% of Control) | | |
| Positive Yield Response (%) | | 84.4% |

As reflected in Table 4, by comparison between control and flavonoid, the yield was enhanced by foliar flavonoid treatment by 5.9 bu/acre, resulting in a 3.3% yield increase over control, and a positive yield enhancement occurred in 84.4% of the trials. Therefore, flavonoids provided yield enhancements as a foliar treatment.

### Example 5

### Field Corn (Maize)

Thirty-six (36) field trials were conducted to evaluate embodiments of the present disclosure on grain yield when applied to corn foliage across the USA and Argentina. The field trials were conducted with various soil characteristics and environmental conditions.

The treatments used in the trials were Control (water/glyphosate solution) and a blend of flavonoids (10 mM concentration of Genistein and Daidzein, in an 8:2 ratio) in formulation (m-pyrol, DMSO, propylene glycol, and Tween 20) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 5

| | YIELD (bu/A) | |
|---|---|---|
| | Control | Treatment |
| Mean (N = 36) | 174.3 | 181.4 |
| Response (bu/A) | | 7.1 |
| Response Increase | | 4.1% |
| (% of Control) | | |
| Positive Yield Response (%) | | 80.6% |

As reflected in Table 5, by comparison between control and flavonoid, the yield was enhanced by foliar flavonoid treatment by 7.1 bu/acre, resulting in a 4.1% yield increase over control, and a positive yield enhancement occurred in 80.6% of the trials. Therefore, flavonoids provided yield enhancements as a foliar treatment.

### Example 6

### Field Corn (Maize)

Twenty-one (21) field trials were conducted to evaluate embodiments of the present disclosure on grain yield when applied to corn foliage across the USA and Argentina. The field trials were conducted with various soil characteristics and environmental conditions.

The treatments used in the trials were Control (water/glyphosate solution) and a blend of flavonoids (10 mM concentration of Genistein and Daidzein, in an 8:2 ratio) in Formulation 3 (Stepan C-40, m-Pyrol, Toximul 8320 and Toximul 3483) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 6

| | YIELD (bu/A) | |
|---|---|---|
| | Control | Treatment |
| Mean (N = 21) | 186.6 | 192.8 |
| Response (bu/A) | | 6.2 |
| Response Increase | | 3.3% |
| (% of Control) | | |
| Positive Yield Response (%) | | 76.2% |

As reflected in Table 6, by comparison between control and flavonoid, the yield was enhanced by foliar flavonoid treatment by 6.2 bu/acre, resulting in a 3.3% yield increase over control, and a positive yield enhancement occurred in 76.2% of the trials. Therefore, flavonoids provided yield enhancements as a foliar treatment.

### Example 7

### Field Corn (Maize)

Nine (9) field trials were conducted to evaluate embodiments of the present disclosure on grain yield when applied to corn foliage across the USA. The field trials were conducted with various soil characteristics and environmental conditions.

The treatments used in the trials were Control (water/glyphosate solution) and a blend of flavonoids (10 mM concentration of Hesperetin and Naringenin, in a 7:3 ratio) in formulation (m-pyrol, DMSO, propylene glycol, and Tween 20) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 7

| | YIELD (bu/A) | |
|---|---|---|
| | Control | Treatment |
| Mean (N = 9) | 186.4 | 194.5 |
| Response (bu/A) | | 8.1 |
| Response Increase | | 4.3% |
| (% of Control) | | |
| Positive Yield Response (%) | | 100% |

As reflected by comparison between control and flavonoid, the yield was enhanced by foliar flavonoid treatment by 8.1 bu/acre, resulting in a 4.3% yield increase over control, and a positive yield enhancement occurred in 100.0% of the trials. Therefore, flavonoids provided yield enhancements as a foliar treatment.

### Example 8

### Field Corn (Maize)

Four (4) field trials were conducted to evaluate embodiments of the present disclosure on grain yield when applied to corn foliage across the USA. The field trials were conducted with various soil characteristics and environmental conditions.

The treatments used in the trials were Control (water/glyphosate solution) and a blend of flavonoids (a 50:50 blend of a 10 mM concentration of Hesperetin and Naringenin, in a 7:3 ratio and a 10 mM concentration of Genistein and Daidzein in an 8:2 ratio) in formulation (Step-flow 26F, Morwet D 454 40%, SAG 30, Propylene glycol, and water) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 8

| | YIELD (bu/A) | |
|---|---|---|
| | Control | Treatment |
| Mean (N = 4) | 160.5 | 165.3 |
| Response (bu/A) | | 4.8 |
| Response Increase | | 3.0% |
| (% of Control) | | |
| Positive Yield Response (%) | | 75.0% |

As reflected in Table 8, by comparison between control and flavonoid, the yield was enhanced by foliar flavonoid treatment by 4.8 bu/acre, resulting in a 3.0% yield increase over control, and a positive yield enhancement occurred in 75.0% of the trials. Therefore, flavonoids provided yield enhancements as a foliar treatment.

### Example 9

### Field Corn (Maize)

Four (4) field trials were conducted to evaluate embodiments of the present disclosure on grain yield when applied to corn foliage across the USA. The field trials were conducted with various soil characteristics and environmental conditions.

The treatments used in the trials were Control (water/glyphosate solution) and a blend of flavonoids (10 mM concentration of Hesperetin and Naringenin, in a 7:3 ratio) in formulation (Step-flow 26F, Morwet D 454 40%, SAG 30, Propylene glycol, and water) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 9

| | YIELD (bu/A) | |
|---|---|---|
| | Control | Treatment |
| Mean (N = 4) | 160.5 | 166.0 |
| Response (bu/A) | | 5.5 |
| Response Increase | | 3.5% |
| (% of Control) | | |
| Positive Yield Response (%) | | 75.0% |

As reflected in Table 9, by comparison between control and flavonoid, the yield was enhanced by foliar flavonoid treatment by 5.5 bu/acre, resulting in a 3.5% yield increase over control, and a positive yield enhancement occurred in 75.0% of the trials. Therefore, flavonoids provided yield enhancements as a foliar treatment.

### Example 10

### Field Corn (Maize)

Nine (9) field trials were conducted to evaluate embodiments of the present disclosure on grain yield when applied to corn foliage across the USA. The field trials were conducted with various soil characteristics and environmental conditions.

The treatments used in the trials were Control (water/glyphosate solution) and a blend of flavonoids (10 mM concentration of Genistein, Daidzein, Hesperetin and Naringenin, in a 1:1:1:1 ratio) in formulation (Step-flow 26F, Morwet D 454 40%, SAG 30, Propylene glycol, and water) at an application rate for 4.0 fl. oz. per acre. Different commercially available corn hybrids were employed. Treatments were sprayed on the foliage at the time of normal herbicide application. Four ounces per acre of the treatment was combined with glyphosate herbicide, plus water and applied at a rate of 5 to 10 gallons per acre. Corn was grown to maturity, harvested and grain yield determined.

TABLE 10

| | YIELD (bu/A) | |
|---|---|---|
| | Control | Treatment |
| Mean (N = 9) | 186.4 | 196.5 |
| Response (bu/A) | | 10.0 |
| Response Increase | | 5.4% |
| (% of Control) | | |
| Positive Yield Response (%) | | 88.9% |

As reflected in Table 10, by comparison between control and flavonoid, the yield was enhanced by foliar flavonoid treatment by 10.0 bu/acre, resulting in a 5.4% yield increase over control, and a positive yield enhancement occurred in 88.9% of the trials. Therefore, flavonoids provided yield enhancements as a foliar treatment.

### Example 11

### Soybean

Twenty-seven (27) field trials were conducted to evaluate embodiments of the present disclosure on grain yield when applied to soybean foliage across the USA and Argentina. The field trials were conducted with various soil characteristics and environmental conditions.

The treatments used in the trials were Control (water/glyphosate solution) and a blend of flavonoids (10 mM concentration of Genistein and Daidzein in an 8:2 ratio) in formulation (Stepan C-40, m-Pyrol, Toximul 8320 and Toximul 3483) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 11

| | YIELD (bu/A) | |
|---|---|---|
| | Control | Treatment |
| Mean (N = 27) | 55.1 | 58.0 |
| Response (bu/A) | | 2.9 |
| Response Increase | | 5.2% |
| (% of Control) | | |
| Positive Yield Response (%) | | 77.8% |

As reflected in Table 11, by comparison between control and flavonoid, the yield was enhanced by foliar flavonoid treatment by 2.9 bu/acre, resulting in a 5.2% yield increase over control, and a positive yield enhancement occurred in 77.8% of the trials. Therefore, flavonoids provided yield enhancements as a foliar treatment.

### Example 12

### Soybean

Thirteen (13) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (10 mM concentration of Genistein and Daidzein in an 8:2 ratio) in formulation (m-pyrol, DMSO, propylene glycol, and Tween 20) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 12

| | YIELD (bu/A) | |
|---|---|---|
| | Control | Treatment |
| Mean (N = 13) | 58.8 | 61.2 |
| Response (bu/A) | | 2.4 |
| Response Increase | | 4.2% |
| (% of Control) | | |
| Positive Yield Response (%) | | 61.5% |

As reflected in Table 12, by comparison between control and flavonoid, the yield was enhanced by foliar flavonoid treatment by 2.4 bu/acre, resulting in a 4.2% yield increase over control, and a positive yield enhancement occurred in 61.5% of the trials. Therefore, flavonoids provided yield enhancements as a foliar treatment.

### Example 13

### Soybean

Thirteen (13) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (10 mM concentration of Genistein and Daidzein in an 8:2 ratio) in formulation (Step-flow 26F, Morwet D 454 40%, SAG 30, Propylene glycol, and water) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 13

| | YIELD (bu/A) | |
|---|---|---|
| | Control | Treatment |
| Mean (N = 13) | 58.8 | 61.4 |
| Response (bu/A) | | 2.6 |
| Response Increase | | 4.4% |
| (% of Control) | | |
| Positive Yield Response (%) | | 76.9% |

As reflected in Table 13, by comparison between control and flavonoid, the yield was enhanced by foliar flavonoid treatment by 2.6 bu/acre, resulting in a 4.4% yield increase over control, and a positive yield enhancement occurred in 76.9% of the trials. Therefore, flavonoids provided yield enhancements as a foliar treatment.

### Example 14

### Soybean

Five (5) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (10 mM concentration of Hesperetin and Naringenin in a 7:3 ratio) in formulation (m-pyrol, DMSO, propylene glycol, and Tween 20) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 14

| | YIELD (bu/A) | |
|---|---|---|
| | Control | Treatment |
| Mean (N = 5) | 58.4 | 60.7 |
| Response (bu/A) | | 2.2 |
| Response Increase | | 3.8% |
| (% of Control) | | |
| Positive Yield Response (%) | | 80.0% |

As reflected in Table 14, by comparison between control and flavonoid, the yield was enhanced by foliar flavonoid treatment by 2.2 bu/acre, resulting in a 3.8% yield increase over control, and a positive yield enhancement occurred in 80.0% of the trials. Therefore, flavonoids provided yield enhancements as a foliar treatment.

### Example 15

### Soybean

Five (5) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (10 mM concentration of Hesperetin and Naringenin in a 7:3 ratio) in formulation (Step-flow 26F, Morwet D 454 40%, SAG 30, Propylene glycol, and water) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 15

| | YIELD (bu/A) | |
|---|---|---|
| | Control | Treatment |
| Mean (N = 5) | 58.4 | 60.4 |
| Response (bu/A) | | 2.0 |
| Response Increase | | 3.4% |
| (% of Control) | | |
| Positive Yield Response (%) | | 60.0% |

As reflected in Table 15, by comparison between control and flavonoid, the yield was enhanced by foliar flavonoid treatment by 2.0 bu/acre, resulting in a 3.4% yield increase over control, and a positive yield enhancement occurred in 60.0% of the trials. Therefore, flavonoids provided yield enhancements as a foliar treatment.

### Example 16

### Soybean

Five (5) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (a 50:50 blend of a 10 mM concentration of Hesperetin and Naringenin, in a 7:3 ratio and a 10 mM concentration of Genistein and Daidzein in an 8:2 ratio) in formulation (Step-flow 26F, Morwet D 454 40%, SAG 30, Propylene glycol, and water) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 16

| | YIELD (bu/A) | |
|---|---|---|
| | Control | Treatment |
| Mean (N = 5) | 58.4 | 60.5 |
| Response (bu/A) | | 2.0 |
| Response Increase | | 3.5% |
| (% of Control) | | |
| Positive Yield Response (%) | | 80.0% |

As reflected in Table 16, by comparison between control and flavonoid, the yield was enhanced by foliar flavonoid treatment by 2.0 bu/A, resulting in a 3.5% yield increase over control, and a positive yield enhancement occurred in 80.0% of the trials. Therefore, flavonoids provided yield enhancements as a foliar treatment.

### Example 17

### Soybean

Five (5) field trials were conducted to evaluate embodiments of the present disclosure on grain yield when applied to soybean foliage across the USA. The field trials were conducted with various soil characteristics and environmental conditions.

The treatments used in the trials were Control (water/glyphosate solution) and a blend of flavonoids (10 mM concentration of Genistein, Daidzein, Hesperetin and Naringenin, in a 1:1:1:1 ratio) in formulation (Step-flow 26F, Morwet D 454 40%, SAG 30, Propylene glycol, and water) at an application rate for 4.0 fl. oz. per acre. Different commercially available soybean varieties were employed. Treatments were sprayed on the foliage at the time of normal herbicide application. Four ounces per acre of the treatment was combined with glyphosate herbicide, plus water and applied at a rate of 5 to 10 gallons per acre. Soybeans were grown to maturity, harvested and grain yield determined.

TABLE 17

| | YIELD (bu/A) | |
|---|---|---|
| | Control | Treatment |
| Mean (N = 5) | 58.4 | 60.0 |
| Response (bu/A) | | 1.6 |
| Response Increase | | 2.8% |
| (% of Control) | | |
| Positive Yield Response (%) | | 80.0% |

As reflected in Table 17, by comparison between control and flavonoid, the yield was enhanced by foliar flavonoid treatment by 1.6 bu/A, resulting in a 2.8% yield increase over control, and a positive yield enhancement occurred in 80.0% of the trials. Therefore, flavonoids provided yield enhancements as a foliar treatment.

It will be understood that the Specification and Examples are illustrative of the present embodiments and that other embodiments within the spirit and scope of the claimed embodiments will suggest themselves to those skilled in the art. Although this disclosure has been described in connection with specific forms and embodiments thereof, it would be appreciated that various modifications other than those discussed above may be resorted to without departing from the spirit or scope of the embodiments as defined in the appended claims. For example, equivalents may be substituted for those specifically described, and in certain cases, particular applications of steps may be reversed or interposed all without departing from the spirit or scope for the embodiments as described in the appended claims.

1. A method for enhancing the growth of a plant or plant part comprising foliarly applying to a plant or plant part one or more flavonoids.

2. The method of claim 1, wherein the one or more flavonoids is selected from the group consisting of catechin (C), gallocatechin (GC), catechin 3-gallate (Cg), gallcatechin 3-gallate (GCg), epicatechins (EC), epigallocatechin (EGC) epicatechin 3-gallate (ECg), epigallcatechin 3-gallate (EGCg), flavan-4-ol, leucoanthocyanidin, proanthocyanidins, luteolin, apigenin, tangeritin, quercetin, quercitrin, rutin, kaempferol, kaempferitrin, astragalin, sophoraflavonoloside, myricetin, fisetin, isorhamnetin, pachypodol, rhamnazin, hesperetin, hesperidin, naringenin, eriodictyol, homoeriodictyol, dihydroquercetin, dihydrokaempferol, cyanidins, delphinidins, malvidins, pelargonidins, peonidins, petunidins, genistein, daidzein, glycitein, equol, lonchocarpane, laxiflorane, calophyllolide, dalbergichromene, coutareagenin, dalbergin, nivetin, and combinations thereof.

3. The method of claim 1, wherein the one or more flavonoids is genistein.

4. The method of claim 1, wherein the one or more flavonoids is daidzein.

5. The method of claim 1, wherein the one or more flavonoids is hesperetin.

6. The method of claim 1, wherein the one or more flavonoids is naringenin.

7. The method of claim 1, wherein the one or more flavonoids is a mixture of genistein and daidzein.

8. The method of claim 7, wherein the ratio between genistein and daidzein is in the range from 10:1 to 1:10, preferably 8:2 to 1:1.

9. The method of claim 1, wherein the one or more flavonoids is a mixture of hesperetin and naringenin.

10. The method of claim 9, wherein the ratio between hesperetin and naringenin is in the range from 10:1 to 1:10, preferably 7:3 to 1:1.

11. The method of claim 1, wherein the one or more flavonoids is a mixture of genistein, daidzein hesperetin, and naringenin.

12. The method of claim 11, wherein the ratio between genistein, daidzein hesperetin, and naringenin is in the range from 10:1:1:1 to 1:10:10:10, preferably 1:1:1:1:1.

13. The method of claim 11, wherein the ratio between genistein, daidzein hesperetin, and naringenin is a 50:50 blend of genistein and daidzein and hesperitin and naringenin wherein the ratio genistein and daidzein is 8:2 and the ratio between hesperitin and naringenin is 7:3.

14. The method of claim 1, wherein the method further comprises applying to the plant or plant part one or more agriculturally beneficial ingredients.

15. The method of claim 14, wherein the step of applying to the plant or plant part one or more agriculturally beneficial ingredients occurs before, during, after, or simultaneously with the step of foliarly applying to plant or plant part with one or more flavonoids.

16. The method of claim 14, wherein the agriculturally beneficial ingredient is a one or more biologically active ingredients.

17. The method of claim 16, wherein the one or more biologically active ingredients are selected from the group consisting of one or more plant signal molecules, one or more beneficial microorganisms, and combinations thereof.

18. The method of claim 1, wherein the plant or plant part is a leguminous plant or plant part, preferably a soybean plant or plant part.

19. The method of claim 1, wherein the plant or plant part is a non-leguminous plant or plant part, preferably a corn plant or plant part.
